(19) United States
(12) Patent Application Publication
(10) Pub. No.: US 2015/0056325 A1
(43) Pub. Date: Feb. 26, 2015

(54) Confectionery Composition, Method Therefor, and Associated Confectionery Articles

(71) Applicant: INTERCONTINENTAL GREAT BRANDS LLC, EAST HANOVER, NJ (US)

(72) Inventor: Kishor Kabse, Morris Plains, NJ (US)

(21) Appl. No.: 14/382,912

(22) PCT Filed: Apr. 23, 2013
(86) PCT No.: PCT/US2013/037697

§ 371 Date: Sep. 4, 2014

Related U.S. Application Data
(60) Provisional application No. 61/638,726, filed on Apr. 26, 2012.

(30) Foreign Application Priority Data
May 25, 2012 (GB) 1209234.2

(51) Int. Cl. A23G 3/38; A23G 4/06; A23G 4/20

(52) U.S. Cl. CPC A23G 3/38; A23G 4/20; A23G 4/06; A23V 2002/00
USPC 426/5; 426/548; 426/3

(57) ABSTRACT

A method of forming a confectionery composition without conventional cooking is disclosed. The method includes blending specific amounts of polyglucitol and water at a temperature of about 50° C. to about 85° C. to form a confectionery composition. Also disclosed are the confectionery compositions and confectionery articles prepared using the method. The confectionery composition can be, for example, a soft candy or a hard candy.

### BACKGROUND OF THE INVENTION

A wide variety of confectionery compositions, including hard and chewy candies, are prepared by blending ingredients that include excess water, then cooking the resulting blend under conditions that drive off a substantial fraction of the added water. In that process, typically a crystalline ingredient is converted into a non-crystalline “glassy” matter. Put simply, many candies are cooked candies. The cooking step is both energy-intensive and time-intensive. The cooking step is also incompatible with many heat-sensitive ingredients. There is therefore a desire for candy-making processes that reduce or eliminate the cooking step.

Cooked chewy candies are typically made by dissolving crystalline ingredients like sugar and polyols with non-crystalline ingredients like corn syrup in water. The initial amount of water used for dissolving the crystalline and non-crystalline sweeteners can be as high as 30 percent or more by weight of the total chewy candy composition. After dissolving the sweeteners water is evaporated or boiled off to reduce the water content to about 6 to 12 weight percent of the chewy candy composition.

Some uncooked candies and associated methods are known. For example, U.S. Pat. No. 5,587,198 to Cherukuri et al. (Cherukuri '198) describes a method of making a confectionery mass, especially nougat, by a positive hydrating step and without need for cooking. However, Cherkuri '198 requires a flash-flow process which involves use of elevated temperatures and high shear force. The high shear force can destroy structures of delicate components and elevated temperatures can cause decay of temperature sensitive components.

Another example is U.S. Pat. No. 6,482,465 to Cherukuri et al. (Cherukuri '465), which describes combining a saccharide-based component with a hydrated hydrobinding component. However, Cherukuri '465 requires high shear mixing which is not desirable for delicate components. Also, Cherukuri '465 uses a large amount of calcium carbonate, which has a chalky texture.

Another example is U.S. Pat. No. 6,517,886 to Chau et al. (“Chau”), which describes combining a saccharide-based component, a hydrated hydrobinding component, and a fat component. However, the process and compositions of Chau are similar to those of Cherukuri. The compositions of Chau contain very large amounts of calcium carbonate and have a chalky texture. Cherukuri '198, Cherukuri '465, and Chau all use granulated components, which cause their final products to have a rough texture. Therefore, these references do not solve the problem of providing an uncooked candy that resembles a cooked candy in taste, texture, and feel.

There remains a need for candy-making processes that reduce or eliminate the cooking step while avoiding the disadvantages of known no-cook methods.

### BRIEF DESCRIPTION OF THE EMBODIMENTS OF THE INVENTION

One embodiment is a method of forming a confectionery composition, the method comprising blending components comprising about 35 to about 95 weight percent of a polyglucitol having a degree of polymerization of at least 3, and about 5 to about 13 weight percent water, at a temperature of about 50° C. to about 85° C. to form a confectionery composition; wherein the confectionery composition retains at least 90 percent of the added water; and wherein all weight percents are based on the weight of the confectionery composition, unless another basis is specified.

Another embodiment is a confectionery composition, comprising about 35 to about 95 weight percent of a polyglucitol having a degree of polymerization of at least 3; and about 5 to about 10 weight percent water.

Yet another embodiment is a confectionery article, comprising a first layer comprising a chewing gum composition; and a second layer disposed on the first layer; wherein the second layer comprises a confectionery composition comprising, based on the weight of the confectionery composition, about 35 to about 95 weight percent of a polyglucitol, and about 5 to about 10 weight percent water.

Another embodiment is a chewing gum composition, comprising a gum base; and a confectionery composition comprising about 35 to about 95 weight percent of a polyglucitol having a degree of polymerization of at least 3, and about 5 to about 10 weight percent water.

These and other embodiments are described in detail below.

### DETAILED DESCRIPTION OF THE INVENTION

The present invention provides a no-cook method for forming confections, including hard candies and chewy candies. The method does not require the use of elevated temperature or high shear force. The method also avoids the need for a hydrated hydrobinding component and components that produce a chalky texture. Further, the present invention eliminates the energy intensive steps such as dissolving confectionery ingredients in water and boiling off water to form a confectionery.

As used herein, the term “confectionery composition” means an edible product comprising a sweet component. Confectionery compositions include medicinal preparations made with sugar, syrup, or honey, and sweet foods such as candy or pastry. Suitable confectionery compositions are well known in the art and include “sugar confectionery” such as hard candy (including, for example, amorphous sugar-glass), toffees, fudges, fondants, jellies, gummies, pastilles, caramels, taffies, nougats, and chewing gums as well as “fat-based confectionery” such as chocolate (including, for example, milk chocolate, dark chocolate, and semi-sweet chocolate), and coatings including, for example, chocolate compound coatings, pastel compound coatings such as white chocolate, and the like.

As used herein, the terms “bubble gum” and “chewing gum” are used interchangeably and are both meant to include any gum composition.

Hard-boiled candies, also known as hard candies, hard sweets, or boiled sweets, are solids and essentially amorphous confectionery products obtained by extensive dehydration of carbohydrate syrups. Hard-boiled candies can be sugar-based or sugar-free. Typically, hard boiled candies have a glassy appearance.

Chewy confectioneries are generally considered to be those confections with soluble components that allow a consumer to experience a chew texture with elasticity for a chew period of more than one minute. Chewy confections include bulk sweeteners, gelling agents, and fats. They can optionally include chew texture modifying agents to modify the chew texture.

As used herein, the term “cooking” refers to heating the contents to a temperature of at least up to 100° Celsius. Traditional methods of forming a confectionery involve cooking the ingredients to boil off water added during the confection forming method.

As used herein, the term “polyglucitol” refers to a hydrogenated polysaccharide. In some embodiments, the polyglucitol has the structure of formula (I)

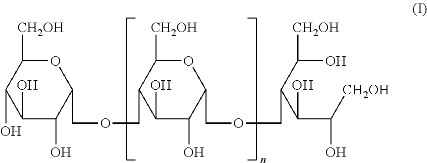

wherein n is at least 1. In general, the polyglucitol has a degree of polymerization of n+2. Thus, when the polyglucitol is described as having a degree of polymerization of at least 3, n is at least 1. In some embodiments, the degree of polymerization is, on a weight average basis, at least about 4, or at least about 5, or at least about 6. In some embodiments, the degree of polymerization is, on average, 3 to about 20, specifically about 4 to about 15, more specifically about 5 to about 12, still more specifically about 5 to about 10.

Methods of producing polyglucitols, including polyglucitols having a degree of polymerization of at least 3, are known in the art and described, for example, in U.S. Reissued Pat. No. 26,959 to Conrad; U.S. Pat. Nos. 4,279,931, 4,346,116, and 4,445,938 to Verwaerde et al.; U.S. Pat. No. 4,457,921 to Stroz; U.S. Patent Application Publication No. US 2003/0131757 A1 of Yang et al.; U.S. patent application Ser. No. 09/276,014, filed Mar. 25, 1999; and International Patent Application Publication No. WO 99/036442 of Barresi et al. If necessary, conventional separation methods, such as liquid chromatography, can be used to obtain a product that has the desired weight percent of polyglucitol having a degree of polymerization of at least 3, while reducing or otherwise managing the weight percent values of sorbitol, maltitol, and other hydrogenated saccharides.

In some embodiments there is provided a method of forming a confectionery composition, comprising blending components comprising about 35 to about 95 weight percent of a polyglucitol having a degree of polymerization of at least 3, and about 5 to about 13 weight percent water, at a temperature of about 50° C. to about 85° C. to form a confectionery composition; wherein the confectionery composition retains at least 90 percent of the added water; and wherein all weight percents are based on the weight of the confectionery composition, unless another basis is specified. Within the range of about 35 to about 95 weight percent, the polyglucitol amount can be about 40 to about 90 weight percent, specifically about 50 to about 85 weight percent, more specifically about 60 to 80 weight percent. Within the range of about 5 to about 13 weight percent, the water amount can be about 6 to about 12 weight percent, and specifically about 7 to about 11 weight percent.

It was surprisingly found that the above method of forming confectionery eliminates the cooking step while forming a confectionery. Since the cooking step is eliminated, the method requires significantly less energy to form the confectionery composition, and heat sensitive components can be incorporated into the confectionery composition. Further, the method reduces the number of steps involved in making a confectionery as compared to traditional manufacturing methods, thereby simplifying industrial automation of the process. In other words, the method reduces or avoids the disadvantages associated with traditional confectionery forming methods which involve cooking. Also, the method produces confectionery compositions which are substantially similar to a cooked candy in taste, texture, and feel.

In some embodiments, the method comprises blending the polyglucitol and the water at about 50° C. to about 85° C. Within the range of 50° C. to 85° C., the blending can be conducted at about 55° C. to about 85° C., specifically about 60° C. to about 85° C. In some embodiments, said forming the confectionery composition is conducted entirely at temperatures less than or equal to about 85° C., specifically at temperatures less than or equal to about 80° C. In these same embodiments, said forming the confectionary composition can, optionally, be conducted entirely at a pressure of about 90 to about 110 kilopascals.

In some embodiments, the confectionery composition retains at least 90 percent of the water added during formation of the confectionery. In some other embodiments, the confectionery composition retains at least 95 percent of the added water, or at least 98 percent of the added water.

In some embodiments, the confectionery composition comprises no more than 10 weight percent, 8 weight percent, 6 weight percent, or 4 weight percent of sorbitol, based on the weight of the confectionery composition. In some other embodiments, the confectionery composition comprises no more than 20 weight percent, 15 weight percent, 10 weight percent, or 5 weight percent of sorbitol, based on the weight of polyglucitol.

In some embodiments, the confectionery composition comprises no more than 20 weight percent, 15 weight percent, 10 weight percent, or 5 weight percent of maltitol, based on the weight of the confectionery composition. In some other embodiments, the confectionery composition comprises no more than 30 weight percent, 25 weight percent, 20 weight percent, 15 weight percent, 10 weight percent, or 5 weight percent of maltitol, based on the weight of polyglucitol.

In some embodiments, the confectionery composition comprises at least 50 weight percent, at least 60 weight percent, at least 70 weight percent, at least 80 weight percent, at least 90 weight percent, or at least 95 weight percent of the polyglucitol based on the total of sorbitol, maltitol, and polyglucitol.

In some embodiments, the method of forming a confectionery composition is a method of forming a hard confectionery composition. The hard confectionery composition can be, for example, a hard candy or a lozenge. In some hard candy embodiments, the confectionery composition is substantially free of hydrocolloids such as gum arabic, carrageenan, locust bean gum, guar gum, and gelatin.

In some hard confectionery embodiments, the confectionery composition comprises about 70 to about 95 weight percent of the polyglucitol, based on the weight of the confectionery composition. Within the range of about 70 to about 95 weight percent, the polyglucitol amount can be about 75 to about 90 weight percent, specifically about 80 to about 90 weight percent, and more specifically about 85 to 90 weight percent.

In some hard confectionery embodiments, in addition to the polyglucitol and the water, the blended components further comprise about 0.5 to about 2 weight percent of an edible fat or oil. Within the range of about 0.5 to about 2 weight percent, the edible fat or oil amount can be about 0.7 to 1.6 weight percent, specifically about 0.9 to about 1.3 weight percent.

The edible fat or oil can be any suitable fat or oil of animal or vegetable origin. In some embodiments the edible fat or oil is selected from the group consisting of hydrogenated palm oil, hydrogenated palm kernel oil, hydrogenated soybean oil, hydrogenated peanut oil, hydrogenated cottonseed oil, hydrogenated coconut oil, and combinations thereof.

Other suitable edible fats or oils include partially or fully hydrogenated vegetable oils, partially or fully hydrogenated animal fats, glycerides, and combinations thereof. In some embodiments, the partially or fully hydrogenated oil or fat is selected from the group consisting of coconut oil, corn oil, palm kernel oil, peanut oil, soy bean oil, sesame oil, cottonseed oil, cocoa butter, milk fat, beef tallow, lard, and combinations thereof. In some embodiments, the oil or fat is partially or fully hydrogenated coconut oil.

The fat can be cocoa butter, cocoa butter substitute, cocoa butter replacers, cocoa butter improvers, or cocoa butter equivalents, among others. Cocoa butter substitute is a lauric fat obtained from the kernel of the fruit of palm trees obtained by fractionation and/or hydrogenation of palm kernel oil. It comprises about 55% lauric acid, about 20% myristic acid, and about 7% oleic acid. The cocoa butter equivalents are vegetable fats with similar chemical and physical characteristics to cocoa butter, which are obtained by blending different fractions of other fats or by inter-esterification, and can be used interchangeably with cocoa butter in any recipe. The cocoa butter replacers are formed by non lauric vegetable fats which may be mixed with cocoa butter but only in limited proportions: they have similar physical, but not chemical characteristics to cocoa butter. Cocoa butter replacers can be used in recipes partially based on cocoa mass or cocoa butter. Cocoa butter improvers are harder; cocoa butter equivalents which are not only equivalent in their compatibility but also improve the hardness of some of the softer qualities of cocoa butter.

In some embodiments, the fat or oil has an iodine value of 10 or less. In some other embodiments, the fat or oil has an iodine value of about 45 to about 55. In some embodiments, the oil or fat has a melting point of about 30 to about 65° C. Within the range of 30 to 65° C., the melting point can be about 35 to about 60° C., specifically about 40 to 55° C.

In some embodiments, the method of forming a confectionery composition is a method of forming a chewy confectionery. In some chewy confectionery embodiments, about 30 to about 70 weight percent of the polyglucitol is provided in the form of a powdered polyglucitol composition comprising, based on the weight of the powdered polyglucitol composition, about 50 to about 99 weight percent polyglucitol having a degree of polymerization of at least 3, and less than or equal to 1 weight percent water; and about 30 to about 70 weight percent of the polyglucitol is provided in the form of a liquid polyglucitol composition comprising, based on the weight of the liquid polyglucitol composition, about 30 to about 80 weight percent polyglucitol having a degree of polymerization of at least 3, and about 20 to about 40 weight percent water.

In some chewy confectionery embodiments, the blended components comprise about 35 to about 50 weight percent of the polyglucitol; and the blended components further comprise about 35 to about 55 weight percent of a polyol selected from the group consisting of sorbitol, mannitol, erythritol, xylitol, maltitol, isomalt, and combinations thereof. Within the range of 35 to about 50 weight percent, the polyglucitol amount can be about 35 to about 45 weight percent, specifically about 35 to 40 weight percent. Within the range of about 35 to about 55 weight percent, the polyol amount can be about 40 to about 50 weight percent. In some embodiments, the polyol comprises sorbitol. The sorbitol can be present in an amount of about 10 to about 30 weight percent based on the weight of the confectionery composition. Within the range of about 10 to about 30 weight percent, the sorbitol amount can be about 15 to 25 weight percent, specifically about 18 to 22 weight percent.

In some chewy confectionery embodiments, the blended components further comprise about 1 to about 10 weight percent of an edible fat or oil. Within the range of about 1 to about 10 weight percent, the edible fat or oil amount can be about 1.5 to about 8 weight percent, specifically about 2 to about 7 weight percent, more specifically about 4 to about 6 weight percent, and even more specifically about 4 to about 5 weight percent.

The edible fat or oil can be any suitable fat or oil including the fats and oils described above. In some embodiments, the edible fat or oil is selected from the group consisting of hydrogenated palm oil, hydrogenated palm kernel oil, hydrogenated soybean oil, hydrogenated peanut oil, hydrogenated cottonseed oil, and combinations thereof.

In some embodiments in which gasification of the confectionery composition is desired, the blended components further comprise about 0.3 to about 3 weight percent of sodium bicarbonate, potassium bicarbonate, or a combination thereof; and about 0.3 to about 2.5 weight percent of a food-grade acid. Suitable food-grade acids include acetic acid, adipic acid, ascorbic acid, butyric acid, citric acid, formic acid, fumaric acid, glyconic acid, lactic acid, phosphoric acid, malic acid, oxalic acid, succinic acid, tartaric acid, and combinations thereof. Within the range of about 0.3 to about 3 weight percent, the amount of sodium bicarbonate, potassium carbonate, or a combination thereof can be about 0.5 to about 2.5 weight percent, specifically about 0.8 to about 2 weight percent, and more specifically, about 1.1 to about 2 weight percent. Within the range of 0.3 to about 2.5 weight percent, the food-grade acid amount can be about 0.5 to about 2 weight percent, specifically about 0.8 to about 1.5 weight percent.

In some embodiments, the blended components further comprise about 1 to about 5 weight percent of a foaming agent. Within the range of about 1 to about 5 weight percent, the foaming agent amount can be about 1.5 to about 4 weight percent, and specifically about 2 to about 3 weight percent. Suitable foaming agents include sodium bicarbonate, and potassium bicarbonate. In one embodiment, the foaming agent is a cappuccino foam booster. Any food-grade foam booster commercially available from companies such as Nestle S.A. or Kraft Foods Inc. can be used.

In some embodiments, the blended components further comprise about 0.5 to about 10 weight percent of a hydrocolloid. Within the range of about 1 to about 10 weight percent, the hydrocolloid amount can be about 1 to about 8 weight percent, specifically about 2 to about 6 weight percent, and more specifically about 3 to 6 weight percent. Suitable hydrocolloids include, for example, gelatin, sodium alginate, carboxymethylcellulose, xanthan gum, guar gum, locust bean gum, carrageenan, pectin, agar, gluten, and combinations thereof.

In some hard candy embodiments, the confectionery composition is substantially free of hydrocolloids. Particularly, in some hard candy embodiments, the confectionery composition is substantially free of gum arabic, carrageenan, locust bean gum, guar gum, gelatin, and combinations thereof.

In some embodiments, the blended components further comprise about 0.01 to about 2 weight percent of a high-intensity sweetener. Within the range of 0.01 to about 2 weight percent, the high-intensity sweetener amount can be about 0.05 to about 1.5 weight percent, specifically about 0.10 to about 1 weight percent, more specifically about 0.20 to about 0.8 weight percent, and even more specifically 0.20 to about 0.60 weight percent.

A “high intensity sweetener” as used herein means agents having a sweetness at least 100 times that of sugar (sucrose) on a per weight basis. In some embodiments the high intensity sweetener has a sweetness at least 150 times that of sugar on a per weight basis, more specifically at least 200 times that of sugar on a per weight basis, even more specifically at least 500 times that of sugar on a per weight basis. The high intensity sweetener can be selected from a wide range of materials, including water-soluble natural and artificial sweeteners, derivatives of water-soluble sweeteners, dipeptide based sweeteners, and protein based sweeteners. Any combination comprising two or more high intensity sweetener can be used. One or more of the high intensity sweeteners can further be combined with one or more of the foregoing sweeteners or sweetening agents. The high intensity sweetener can be used in a variety of distinct physical forms, for example those known in the art to provide an initial burst of sweetness and/or a prolonged sensation of sweetness. Without being limited thereto, such physical forms include free forms (e.g., spray dried or powdered), beaded forms, encapsulated forms, and combinations of the foregoing forms.

Without being limited to particular sweetening agents, representative categories and examples include (1) water-soluble sweetening agents such as dihydrochalcones, monellin, steviosides, Rebaudioside A, Rebaudioside B, Rebaudioside C, glycyrrhizin, dihydroflavenol, and sugar alcohols such as sorbitol, mannitol, maltitol, monatin, and L aminodicarboxylic acid aminoalkenoic acid ester amides, such as those disclosed in U.S. Pat. No. 4,619,834 to Zanno et al., or a combination comprising at least one of the foregoing; (2) water-soluble artificial sweeteners such as saccharin, soluble saccharin salts, such as, sodium or calcium saccharin salts, cyclamate salts, acesulfame salts, such as the sodium, ammonium or calcium salt of 3,4-dihydro-6-methyl-1,2,3-oxathiazine-4-one 2,2 dioxide, the potassium salt of 3,4-dihydro-6-methyl-1,2,3-oxathiazine-4-one-2,2-dioxide (Acesulfame-K), the free acid form of saccharin, or a combination comprising at least one of the foregoing; (3) dipeptide based sweeteners, for example the L-aspartic acid derived sweeteners such as L-aspartyl-L-phenylalanine methyl ester (Aspartame) and materials described in U.S. Pat. No. 3,492,131 to Schlatter et al., L-alpha-aspartyl-N-(2,2,4,4-tetramethyl-3-thietanyl)-D-alaninamide hydrate (Alitame), methyl esters of L-aspartyl-L-phenylglycine and L-aspartyl-L-2,5-dihydrophenyl-glycine, L-alpha aspartyl-L-phenylglycine methyl ester, L-alpha aspartyl-L-2,5-dihydrophenylglycine methyl ester, L-aspartyl-2,5-dihydro-L-phenylalanine, L-alpha aspartyl-2,5-dihydrophenylalanine methyl ester, L-aspartyl-L-(1-cyclohexen)-alanine, N—(N-(3,3-dimethylbutyl)-L-alpha-aspartyl)-L-phenylalamine methyl ester (Neotame), or a combination thereof; (4) derivatives of water-soluble sweeteners, such as derivatives of steviosides, derivatives of Rebaudioside A, derivatives of Rebaudioside B, derivatives of Rebaudioside C, chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose, examples of chlorodeoxysucrose and chlorodeoxygalactosucrose derivatives include 1-chloro-1′-deoxysucrose, 4-chloro-4-deoxy-alpha-D-galactopyranosyl-alpha-D-fructofuranoside, 4-chloro-4-deoxygalactosucrose, 4-chloro-4-deoxy-alpha-D-galactopyranosyl-1-chloro-1-deoxy-beta-D-fructofuranoside, 4,1′-dichloro-4,1′-dideoxygalactosucrose; 1′,6′-dichloro-1′,6′-dideoxysucrose, 1,6 dichloro-1,6-dideoxy-β-D-fructofuranosyl-4-chloro-4-deoxy-α-D-galactopyranoside, 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose, 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose, 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro-4,6,1′,6′-tetradeoxygalacto-sucrose, 4,6,1′,6′-tetradeoxy-sucrose, or a combination thereof; (5) protein based sweeteners such as thaumaoccous danielli, thaumatin, talin, or a combination thereof; and (6) amino acid based sweeteners.

In some embodiments, the high-intensity sweetener is selected from the group consisting of Acesulfame potassium (CAS Reg. No. 55589-62-3), N-(L-α-aspartyl)-L-phenylalanine 1-methyl ester (commonly known as ASPARTAME; CAS Reg. No. 22839-47-0), 1,6-dichloro-1,6-dideoxy-β-D-fructofuranosyl-4-chloro-4-deoxy-α-D-galactopyranoside (commonly known as SUCRALOSE; CAS Reg. No. 56038-13-2), and combinations thereof.

In some embodiments of the method of forming a confectionery composition, the confectionery composition is a hard candy. In a very specific hard candy embodiment, the method of forming a confectionery composition is conducted entirely at temperatures less than or equal to 85° C.; the blended components comprise about 70 to about 95 weight percent of the polyglucitol; the confectionery composition comprises less than or equal to 10 weight percent sorbitol; the confectionery composition comprises less than or equal to 20 weight percent maltitol; the amount of the polyglucitol is at least 60 weight percent of the total of sorbitol, maltitol, and polyglucitol; the blended components further comprise about 0.5 to about 2 weight percent of an edible fat or oil; and the blended components are substantially free of gum arabic, carrageenan, locust bean gum, guar gum, and gelatin. Within the range of about 70 to about 95 weight percent, the polyglucitol amount can be about 75 to about 95 weight percent, specifically about 80 to about 95 weight percent, and more specifically about 85 to about 95 weight percent. The confectionery composition can comprise sorbitol in an amount less than or equal to 10 weight percent, less than or equal to 8 weight percent, less than or equal to 6 weight percent, or less than or equal to 4 weight percent. The confectionery composition can comprise maltitol in an amount less than or equal to 20 weight percent, less than or equal to 15 weight percent, less than or equal to 10 weight percent, or less than or equal to 5 weight percent. The amount of the polyglucitol can be at least 60, at least 70, at least 80, at least 90, or at least 95 weight percent of the total of sorbitol, maltitol, and polyglucitol. Within the range of 0.5 to 2 weight percent, the edible fat or oil amount can be about 0.7 to about 1.6 weight percent, specifically about 0.9 to about 1.3 weight percent.

In some embodiments of the method of forming a confectionery composition, the confectionery composition is a chewy candy. In a very specific chewy candy embodiment, the method of forming the confectionery composition is conducted entirely at temperatures less than or equal to 85° C.; the polyglucitol is provided in the form of a blend of (a) about 30 to about 70 weight percent of a powdered polyglucitol composition comprising, based on the weight of the powdered polyglucitol composition, about 50 to about 99 weight percent polyglucitol having a degree of polymerization of at least 3, and less than or equal to 1 weight percent water, and
(b) about 30 to about 70 weight percent of a liquid polyglucitol composition comprising based on the weight of the liquid polyglucitol composition, about 30 to about 80 weight percent polyglucitol having a degree of polymerization of at least 3, and about 20 to about 40 weight percent water; and the blended components further comprise about 1 to about 10 weight percent of an edible fat or oil. Within the range of about 1 to about 10 weight percent, the edible fat or oil amount can be about 1.5 to about 8 weight percent, specifically about 2 to about 7 weight percent, more specifically about 3 to about 6 weight percent, and even more specifically about 4 to about 5 weight percent.

In some embodiments, there is provided a confectionery composition, comprising about 35 to about 95 weight percent of a polyglucitol having a degree of polymerization of at least 3, and about 5 to about 10 weight percent water. Within the range of about 35 to about 95 weight percent, the polyglucitol amount can be about 40 to about 90 weight percent, about 50 to about 85 weight percent, about 60 to 80 weight percent, or about 70 to about 75 weight percent. The polyglucitol can have a degree of polymerization of at least 3, at least 4, at least 5, at least 6, at least 7, at least 8, at least 9, or at least 10. Within the range of about 5 to about 10 weight percent, the water amount can be about 6 to about 9 weight percent, or about 7 to about 8 weight percent.

In some hard candy embodiments, the confectionery composition comprises about 80 to about 95 weight percent of polyglucitol. In some other embodiments, the polyglucitol amount is about 85 to 95 weight percent.

In some hard candy embodiments, the confectionery composition further comprises about 0.5 to about 2 weight percent of an edible fat or oil. Within the range of about 0.5 to about 2 weight percent, the edible fat or oil can be about 0.7 to about 1.6 weight percent, or about 0.9 to about 1.3 weight percent. Suitable edible fats and oils are described above.

In some chewy candy embodiments, the confectionery composition comprises about 35 to about 50 weight percent of the polyglucitol, and further comprises about 35 to about 55 weight percent of a polyol selected from the group consisting of sorbitol, mannitol, erythritol, xylitol, maltitol, isomalt, and combinations thereof. Within the range of about 35 to about 50 weight percent, the polyglucitol amount can be about 35 to about 45 weight percent, or about 35 to about 40 weight percent. Within the range of about 35 to about 55 weight percent, the polyol amount can be about 40 to about 50 weight percent.

In some chewy candy embodiments, the confectionery composition further comprises about 1 to about 10 weight percent of an edible fat or oil. Within the range of about 1 to about 10 weight percent, the edible fat or oil amount can be about 1.5 to about 8 weight percent, specifically about 2 to about 7 weight percent, more specifically about 3 to about 6 weight percent, or even more specifically about 4 to about 5 weight percent. Suitable fats and oils are described above.

In some chewy candy embodiments, the edible fat or oil is selected from the group consisting of hydrogenated palm oil, hydrogenated palm kernel oil, hydrogenated soybean oil, hydrogenated peanut oil, hydrogenated cottonseed oil, and combinations thereof.

In some chewy candy embodiments, the confectionery composition further comprises about 0.5 to about 10 weight percent of a hydrocolloid. Within the range of 0.5 to about 10 weight percent, the hydrocolloid amount can be about 1 to about 8 weight percent, about 2 to about 6 weight percent, about 3 to about 6 weight percent, or about 4 to about 6 weight percent. In some embodiments, the hydrocolloid is selected from the group consisting of gelatin, sodium alginate, carboxymethylcellulose, and combinations thereof.

In some chewy candy embodiments, the confectionery composition further comprises about 1 to about 10 weight percent of gluten. Within the range of about 1 to about 10 weight percent, the gluten amount can be about 2 to about 9 weight percent, or about 4 to about 8 weight percent.

In some embodiments, the confectionery composition further comprises about 0.01 to about 2 weight percent of a high-intensity sweetener. Within the range of about 0.01 to about 2 weight percent, the high-intensity sweetener amount can be about 0.05 to about 1.5 weight percent, about 0.10 to about 1 weight percent, about 0.20 to about 0.8 weight percent, or about 0.20 to about 0.6 weight percent.

In some embodiments, the high-intensity sweetener is selected from the group consisting of Acesulfame potassium (CAS Reg. No. 55589-62-3), N-(L-α-aspartyl)-L-phenylalanine-1-methyl ester (also known as ASPARTAME; CAS Reg. No. 22839-47-0), 1,6-dichloro-1,6-dideoxy-β-D-fructofuranosyl-4-chloro-4-deoxy-α-D-galactopyranoside (also known as SUCRALOSE, CAS Reg. No. 56038-13-2), and combinations thereof. The confectionery composition may comprise any other high-intensity sweetener described above.

In a very specific hard candy embodiment, the confectionery composition comprises about 70 to about 95 weight percent of the polyglucitol; the confectionery composition comprises less than or equal to about 10 weight percent sorbitol; the confectionery composition comprises less than or equal to about 20 weight percent maltitol; the amount of the polyglucitol is at least 60 weight percent of the total of sorbitol, maltitol, and polyglucitol; and the confectionery composition further comprises about 0.5 to about 2 weight percent of an edible fat or oil. Within the range of about 70 to about 95 weight percent, the polyglucitol amount can be about 75 to about 95 weight percent, about 80 to about 95 weight percent, or about 85 to about 95 weight percent. The confectionery composition can comprise sorbitol in an amount less than or equal to about 10 weight percent, less than or equal to about 8 weight percent, less than or equal to about 6 weight percent, or less than or equal to about 4 weight percent. The confectionery composition can comprise maltitol in an amount less than or equal to about 20 weight percent, less than or equal to about 15 weight percent, less than or equal to about 10 weight percent, or less than or equal to about 5 weight percent. The amount of polyglucitol can be at least 60, at least 70, at least 80, at least 90 or at least 95 weight percent of the total of sorbitol, maltitol, and polyglucitol.

In a very specific chewy candy embodiment, the confectionery composition comprises about 35 to about 50 weight percent of the polyglucitol; the confectionery composition further comprise about 35 to about 55 weight percent of a polyol selected from the group consisting of sorbitol, mannitol, erythritol, xylitol, maltitol, isomalt, and combinations thereof; and the confectionery composition further comprises about 1 to about 10 weight percent of an edible fat or oil. Within the range of about 35 to about 50 weight percent, the polyglucitol amount can be about 35 to about 45 weight percent, or about 35 to about 40 weight percent. Within the range of about 35 to about 55 weight percent, the polyol amount can be about 40 to about 50 weight percent. Within the range of about 1 to about 10 weight percent, the edible fat or oil amount can be about 1.5 to about 8 weight percent, about 2 to about 7 weight percent, about 3 to about 6 weight percent, or about 4 to about 5 weight percent.

In some embodiments, there is provided a confectionery article, comprising a first layer comprising a chewing gum composition; and a second layer disposed on the first layer; wherein the second layer comprises a confectionery composition comprising, based on the weight of the confectionery composition, about 35 to about 95 weight percent of a polyglucitol, and about 5 to about 10 weight percent water. Within the range of about 35 to about 95 weight percent, the polyglucitol amount can be about 40 to about 90 weight percent, about 50 to about 85 weight percent, about 60 to about 80 weight percent, or about 70 to about 75 weight percent. Within the range of about 5 to about 10 weight percent, the water amount can be about 6 to about 9 weight percent, or about 7 to about 8 weight percent. In some embodiments, the confectionery article is prepared by co-extrusion of the chewing gum composition and the confectionery composition.

The confectionery article can further comprise at least one humectant present in the confectionery composition. The humectants prevent loss of moisture from the confectionery composition. The humectants also prevent migration of moisture from the confectionery composition to the chewing gum composition. Suitable humectants include glycerol, sorbitol, polyethylene glycol, erythritol, xylitol, and combinations thereof. In some embodiments, the humectants are present in an amount of about 0.01 to about 2 weight percent of the confectionery composition. Within this range, the humectant amount can be about 0.05 to about 1.25 weight percent, specifically about 0.1 to 1 weight percent.

In some embodiments there is provided a chewing gum composition, comprising a gum base, and a confectionery composition, comprising about 35 to about 95 weight percent of a polyglucitol having a degree of polymerization of at least 3; and about 5 to about 10 weight percent water.

The chewing gum composition can be prepared using standard techniques and equipment. In some embodiments, the confectionery composition is added at the end of the chewing gum ingredients mixing process and mixed enough to form a homogenous mass comprising microscopic regions of the confectionery composition within the chewing gum matrix. However, the processes described herein are not necessarily limited to addition of the confectionery composition at the end of the mixing process and it can be added at any desired stage of the chewing gum manufacturing process. The chewing gum can contain a discrete phase of the confectionery composition dispersed in a continuous chewing gum phase.

In one exemplary process, a gum base is heated to a temperature sufficiently high to soften the base without adversely affecting the physical and chemical make-up of the base, which will vary depending upon the composition of the gum base used, and is readily determined by those skilled in the art without undue experimentation. For example, the gum base can be conventionally melted to about 60° C. to about 160° C., or melted to about 150° C. to about 175° C., for a period of time sufficient to render the base molten, e.g., about thirty minutes, just prior to being admixed incrementally with the remaining ingredients of the base such as the plasticizer, fillers, and softener to plasticize the blend as well as to modulate the hardness, viscoelasticity and formability of the base, the chewing gum ingredients are next blended with the gum base, with the confectionery composition being added at the end of the process. Mixing is continued until a uniform or homogeneous mixture of the chewing gum composition is obtained. Thereafter the chewing gum composition can be formed into a desired shape.

In another exemplary process, chewing gum ingredients are mixed with gum base, with the confectionery composition being added at the end of the process. Mixing is continued until a uniform or homogeneous mixture of the chewing gum composition is obtained. Thereafter the chewing gum composition can be formed into a desired shape. Within this embodiment, the starting gum base can be in an un-molten form, such as in the form of a pelletized gum base, that can be softened at 40 to 50° C. rather than melting at higher temperatures as in the prior embodiment.

The chewing gum composition can be prepared using a batch method or a continuous method or a combination thereof.

The processing equipment used to prepare the chewing gum composition can be monitored and/or controlled automatically. For example, the processing equipment can be coupled to a computerized system which allows the user to input certain and/or all of the operational parameters, including, e.g., feeding of the ingredients, mixing or processing the ingredients, conveying the ingredients. In an embodiment, the system can be coupled to batch processing equipment, continuous processing equipment, or both if both types are used. In an embodiment, changing the input parameters used to control the processing can create changes in the final composition, e.g., ingredient amount and type, etc. For example, the ingredient and/or processing temperatures and/or feed rates of the ingredients can be monitored and fed back to a central unit so that the operator can adjust as needed and/or in which the system can automatically adjust. After the ingredients have been mixed, the formation, processing into a particular shape and/or form can also be monitored and fed back for the operators input and/or automatic adjustment. An audible and/or visual alarm can also be implemented to signal the operator when the system detects a problem and/or a variation in one or more processing parameters.

The chewing gum composition can be formed using a variety of processes including an extrusion process, a co-extrusion process, a triple extrusion process, a laminate process, a molding process, a compression process, a rolling and scoring process, a chain die process, a rotary die process, or a cut and wrap process.

The chewing gum composition can be shaped using devices and techniques that are known in the confectionery art. For example, the chewing gum composition can be shaped by hand, with molds and/or dies, cutters, pullers, stretchers, extruders and the like. Non-limiting examples of molds that can be used include, flexible (e.g., made of silicone), metal, plastic, glass, and the packaging itself (e.g., by placing the unshaped mass into the pack), such as a blister pack. Combinations of these may also be employed.

The chewing gum composition can be prepared into discrete units in the form of slabs, sticks, pellets, balls, cubes, and the like. The formation into discrete units can be achieved using a chain die, or rolling and scoring process.

Chewing gums generally contain a water-insoluble gum base, sweeteners, natural or artificial flavors, and a variety of additional components tailored to provide specific release characteristics. For example, some chewing gums can include plasticizers or softeners to improve consistency during chew. Other chewing gums, for instance, can include physiological cooling agents to provide a cooling sensation upon consumption by the user. Oral delivery of actives, such as flavors, sweeteners, sensates and therapeutic agents, for their intended purpose, is one of the main objectives of chewing gum compositions.

A chewing gum composition may further comprise one or more additional ingredients (or additives). Suitable additives include sweetening agents, flavor modulators or potentiators, flavorants, aroma agents, coolants, warming agents, coloring agents, breath fresheners, mouth moisteners, humectants, acidulants, buffering agents, tingling agents, oral care agents, throat care agents, medicaments, antioxidants, preservatives, and combinations thereof. Some of these additives can serve more than one purpose. For example, a sweetening agent such as sucrose, sorbitol, other sugar alcohols, and combinations thereof can also function as a bulking agent. A combination comprising at least one of the foregoing additional ingredients is often used.

In some embodiments, the confectionery composition comprises less than or equal to 20 weight percent lactitol, specifically less than or equal to 15 weight percent lactitol, even more specifically less than or equal to 10 weight percent lactitol. In some embodiments, the lactitol amount can be less than or equal to 5 weight percent, and specifically less than or equal to 2 weight percent. In some embodiments, the confectionery composition excludes lactitol.

In some embodiments, the confectionery composition comprises less than 20 weight percent of crystalline constituents. In some embodiments, the amount of crystalline constituents can be less than 15 weight percent, specifically less than 10 weight percent, and more specifically less than 5 weight percent. In some embodiments the confectionery composition excludes crystalline constituents.

In some embodiments, the confectionery composition comprises less than or equal to 0.2 weight percent isomalt based of the total of isomalt and polyglucitol. In some embodiments, the confectionery comprises less than or equal to 0.1 weight percent of isomalt based of the total of isomalt and polyglucitol. In some other embodiments, the confectionery composition excludes isomalt.

The confectionery composition can, optionally, further comprise one or more additional ingredients (or additives). Suitable additives include flavor modulators and potentiators, flavorants, aroma agents, coolants, warming agents, coloring agents, breath fresheners, mouth moisteners, humectants, acidulants, buffering agents, tingling agents, oral care agents, throat care agents, medicaments, antioxidants, preservatives, and combinations thereof.

In a confectionery composition, a sweet taste can come not only from sweetening agents but also from flavor modulators or potentiators and/or from flavorants. Flavor modulators can impart a characteristic of their own that complements or negates a characteristic of another component. For example, flavors can be compounded to have additional sweet notes by the inclusion of flavor modulators or potentiators, such as vanilla, vanillin, ethyl maltol, furfural, ethyl propionate, lactones, and combinations thereof. The flavor modulators can be used in an amount about 0.01 to about 30 weight percent of the confectionery composition depending on the desired intensity of the aromas used. In some embodiments, the content of the flavor modulators is in the range of about 0.2 to about 3 weight percent of the confectionery composition.

Flavor potentiators are materials that intensify, supplement, modify, or enhance the taste or aroma perception of an original material without introducing a characteristic taste or aroma perception of their own. In some embodiments, flavor potentiators are designed to intensify, supplement, modify, or enhance the perception of flavor, sweetness, tartness, umami, kokumi, saltiness, or a combination thereof. The flavor potentiators can be used in the amount about 0.01 to about 30 weight percent of the confectionery composition depending on the desired intensity of the aromas used. Preferably, the content of the flavor potentiators is in the range of about 0.2 to about 3 weight percent of the confectionery composition.

Exemplary flavor modulators or potentiators include monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, neotame, thaumatin, neohesperidin dihydrochalcone, tagatose, trehalose, maltol, ethyl maltol, phyllodulcin, vanilla extract, vanilla oleoresin, vanillin, sugar beet extract (alcoholic extract), sugarcane leaf essence (alcoholic extract), compounds that respond to G-protein coupled receptors (T2Rs and T1Rs), and combinations thereof. In some embodiments, sugar acids, sodium chloride, potassium chloride, sodium acid sulfate, or a combination comprising at least one of the foregoing are used. In other embodiments, glutamates such as monosodium glutamate, monopotassium glutamate, hydrolyzed vegetable protein, hydrolyzed animal protein, yeast extract, and combinations thereof are included. Further examples include adenosine monophosphate (AMP), glutathione, and nucleotides such as inosine monophosphate, disodium inosinate, xanthosine monophosphate, guanylate monophosphate, and combinations thereof. Further examples of flavor potentiator compositions that impart kokumi are also included in U.S. Pat. No. 5,679,397 to Kuroda et al.

Flavorants (also known as flavorings, flavors, or flavoring agents) that can be used include those artificial and natural flavors known in the art, for example synthetic flavor oils, natural flavoring aromatics and/or oils, oleoresins, extracts derived from plants, leaves, flowers, fruits, and the like, and combinations comprising at least one of the foregoing flavorants. Non-limiting representative flavors include oils such as spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, cassia oil, and citrus oils including lemon, orange, lime, grapefruit, vanilla, fruit essences, including apple, pear, peach, grape, strawberry, raspberry, blackberry, cherry, plum, pineapple, apricot, banana, melon, tropical fruit, mango, mangosteen, pomegranate, papaya, honey lemon, and the like, and combinations thereof. Specific flavorants are mints such as peppermint, spearmint, artificial vanilla, cinnamon derivatives, and various fruit flavors.

Examples of artificial, natural, and synthetic fruit flavorants include coconut, coffee, chocolate, vanilla, lemon, grapefruit, orange, lime, yazu, sudachi, menthol, licorice, caramel, honey, peanut, walnut, cashew, hazelnut, almonds, pineapple, strawberry, raspberry, blackberry, tropical fruits, cherries, cinnamon, peppermint, wintergreen, spearmint, eucalyptus, and mint, fruit essence such as from apple, pear, peach, grape, blueberry, strawberry, raspberry, cherry, plum, pineapple, apricot, banana, melon, apricot, ume, cherry, raspberry, blackberry, tropical fruit, mango, mangosteen, pomegranate, papaya, and the like, and combinations thereof.

Other types of flavorants include various aldehydes and esters such as cinnamyl acetate, cinnamaldehyde, citral diethylacetal, dihydrocarvyl acetate, eugenyl formate, p-methylamisol, acetaldehyde (apple), benzaldehyde (cherry, almond), anisic aldehyde (licorice, anise), cinnamic aldehyde (cinnamon), alpha-citral (lemon, lime), neral, beta-citral (lemon, lime), decanal (orange, lemon), ethyl vanillin (vanilla, cream), heliotrope, piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, trans-2-(berry fruits), tolyl aldehyde (cherry, almond), veratraldehyde (vanilla), 2,6-dimethyl-5-heptenal, melonal (melon), 2,6-dimethyloctanal (green fruit), 2-dodecenal (citrus, mandarin), and combinations thereof.

Other potential flavors whose release profiles can be managed include a milk flavor, a butter flavor, a cheese flavor, a cream flavor, a yogurt flavor, a vanilla flavor, a tea or coffee flavor, such as a green tea flavor, a oolong tea flavor, a cocoa flavor, a chocolate flavor, a mint flavor, such as peppermint, spearmint, and Japanese mint; spicy flavors, such as asafetida, ajowan, anise, angelica, fennel, allspice, cinnamon, chamomile, mustard, cardamom, caraway, cumin, clove, pepper, coriander, sassafras, savory, Zanthoxyli Fructus, perilla, juniper berry, ginger, star anise, horseradish, thyme, a tarragon, dill, capsicum, nutmeg, basil, marjoram, rosemary, bay leaf, and wasabi; alcoholic flavors, such as wine, whisky, brandy, rum, gin, and liqueur; floral and vegetable flavors, such as onion, garlic, cabbage, carrot, celery, mushroom, tomato, and any combinations thereof. Commonly used flavorings include mints such as peppermint, menthol, spearmint, artificial vanilla, cinnamon derivatives, and various fruit flavors, whether employed individually or in admixture. Flavors can also provide breath freshening properties, particularly the mint flavors when used in combination with cooling agents. In some embodiments, the composition can further include fruit juices.

The flavoring agents can be used in many distinct physical forms. Such physical forms include liquid and/or dried form. In some embodiments, the flavoring agents can be in free (unencapsulated) forms, spray dried forms; freeze dried forms, powdered forms, beaded forms, encapsulated forms, slices, pieces, and mixtures thereof. When employed in a spray-dried form, suitable drying means such as spray-drying a liquid can be used. Alternatively, the flavoring agent can be absorbed onto water-soluble materials, such as cellulose, starch, sugar, maltodextrin, gum arabic and so forth or it can be encapsulated. In still other embodiments, the flavoring agent can be adsorbed onto water-insoluble materials such as silicas, zeolites, and the like. The particle size of the flavoring agents can be less than 3 millimeters, less than 2 millimeters, or less than 1 millimeter, calculated as the longest dimension of the particle. The flavoring agent can have a particle size about 3 micrometers to 2 millimeters, specifically about 4 micrometers to about 1 millimeter. The flavorants can be used in the amount about 0.01 to about 30 weight percent of the confectionery composition depending on the desired intensity of the aromas used. Preferably, the content of the flavorants is in the range of about 0.2 to about 3 weight percent of the confectionery composition.

The amount of flavor modulators, flavor potentiators, and flavorants used herein can be a matter of preference subject to such factors as the type of final confectionery product composition, the individual flavor, and the strength of flavor desired. Thus, the amount of flavorants can be varied in order to obtain the result desired in the final product and such variations are within the capabilities of those skilled in the art without the need for undue experimentation.

In some embodiments, the confectionery composition contains aroma agents including natural and synthetic flavorings such as natural vegetable components, flavoring aromatics and/or oils, essential oils, essences, extracts, powders, food-grade acids, oleoresins and extracts derived from plants, leaves, flowers, fruits, and the like, and combinations thereof. The aroma agents can be in liquid or powdered form. The aroma agents can be used in the amount about 0.01 to about 30 weight percent of the confectionery composition depending on the desired intensity of the aromas used. Preferably, the content of the aroma agents is in the range of about 0.2 to about 3 weight percent of the confectionery composition.

Cooling agents, also known as coolants, are additives that provide a cooling or refreshing effect in the mouth, in the nasal cavity, or on skin. Menthyl-based coolants as used herein include menthol and menthol derivatives. Menthol (also known as 2-(2 propyl)-5-methyl-1-cyclohexanol) is available in artificial form, or naturally from sources such as peppermint oil. Menthol derivatives include menthyl ester based and menthyl carboxamide-based cooling compounds such as menthyl carboxamide, N-ethyl-p-menthane carboxamide, monomenthyl succinate, monomenthyl methyl succinate, monomenthyl glutarate, menthyl 2-pyrrolidone-5 carboxylate, monomenthyl 3-methyl maleate, menthyl acetate, menthyl lactate, menthyl salicylate, 2-isopropanyl-5-methylcyclohexanol, 3-L-menthoxypropane-1,2-diol, menthane, menthone, menthone ketals, menthone glycerol ketals, menthyl glutarate esters, N-ethyl-p-menthane-3-carboxamide (WS-3), or a combination thereof. Additional menthyl-based coolants, specifically menthylcarboxamides, are described in U.S. Pat. No. 7,923,577 to Bardsley et al.

Other cooling agents that can be used in combination with or in the absence of the menthyl-based coolants include, for example 2-mercapto-cyclo-decanone, hydroxycarboxylic acids with 2 to 6 carbon atoms, xylitol, erythritol, alpha-dimethyl succinate, acyclic carboxamides such as N-2,3-trimethyl-2-isopropyl butanamide, N-ethyl-2,2-diisopropylbutanamide, and combinations thereof. Additional cooling agents include the 1-tert-butylcyclohexanecarboxamides described in U.S. Patent Application Publication Nos. US 2011/0070171 A1 and US 2011/0070329 A1 of Kazimierski et al.

Cooling compositions comprising a primary cooling compound, a secondary cooling compound, and an ingestible non-polar solvent are described in U.S. Patent Application Publication No. US 2011/0091531 A1 of Furrer et al. The cooling agents can be present in a suitable amount depending upon the desired level of cooling intensity. In some embodiments, the cooling agents are present in an amount of about 0.01 to about 1.5 weight percent of the confectionery composition. Within the range of about 0.01 to about 1.5 weight percent, the cooling agent amounts can be about 0.05 to about 1.25 weight percent, specifically about 0.1 to 1 weight percent.

Warming agents can be selected from a wide variety of compounds known to provide the sensory signal of warming to the user. These compounds offer the perceived sensation of warmth, particularly in the oral cavity, and often enhance the perception of flavors, sweeteners and other organoleptic components. Among the useful warming compounds included are vanillyl alcohol n-butylether (TK-1000) supplied by Takasago Perfumary Company Limited, Tokyo, Japan, vanillyl alcohol methyl ether, vanillyl alcohol ethyl ether, vanillyl alcohol n-propyl ether, vanillyl alcohol isopropyl ether, vanillyl alcohol isobutyl ether, vanillyl alcohol n-pentyl ether, vanillyl alcohol isoamyl ether, vanillyl alcohol n-hexylether, gingerol, shogaol, paradol, zingerone, capsaicin, dihydrocapsaicin, nordihydrocapsaicin, homocapsaicin, homodihydrocapsaicin, ethanol, isopropyl alcohol, isoamyl alcohol, benzyl alcohol, glycerin, and combinations thereof. The warming agents can be present in a suitable amount depending upon the desired level of warming intensity. In some embodiments, the warming agents are present in an amount of about 0.01 to about 1.5 weight percent of the confectionery composition. Within the range of about 0.01 to about 1.5 weight percent, the warming agent amounts can be about 0.05 to about 1.25 weight percent, specifically about 0.1 to about 1 weight percent.

Coloring agents (also known as colorants or colorings) can be used in amounts effective to produce a desired color for the confectionery composition. Suitable coloring agents include pigments, which can be incorporated in amounts up to about 6 weight percent by weight of the confectionery composition. For example, titanium dioxide can be incorporated in amounts of about 0.1 to about 2 weight percent and specifically about 0.15 to about 1 weight percent by weight of the confectionery composition. Suitable coloring agents also include natural food colors and dyes suitable for food, drug, and cosmetic applications.

Suitable colorants include annatto extract (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rho do xanthin (E161f), caramel (E150(a-d)), β-apo-8′-carotenal (E160e), β-carotene (E160a), alpha-carotene, gamma-carotene, ethyl ester of beta-apo-8 carotenal (E160f), flavoxanthin (E161a), lutein (E161b), cochineal extract (E120), carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminum (E173), silver (E174), gold (E175), pigment rubine/lithol rubine BK (E180), calcium carbonate (E170), carbon black (E153), black PN/brilliant black BN (E151), green S/acid brilliant green BS (E142), FD&C aluminum lakes, and combinations thereof. The coloring agents can be present in a suitable amount depending upon the desired level of coloring intensity. In some embodiments, the coloring agents are present in an amount of about 0.005 to about 1.25 weight percent of the confectionery composition. Within the range of about 0.005 to about 1 weight percent, the coloring agents can be about 0.01 to about 1 weight percent, specifically about 0.02 to 0.8 weight percent.

Exemplary breath fresheners include zinc citrate, zinc acetate, zinc fluoride, zinc ammonium sulfate, zinc bromide, zinc iodide, zinc chloride, zinc nitrate, zinc fluorosilicate, zinc gluconate, zinc tartarate, zinc succinate, zinc formate, zinc chromate, zinc phenol sulfonate, zinc dithionate, zinc sulfate, silver nitrate, zinc salicylate, zinc glycerophosphate, copper nitrate, chlorophyll, copper chlorophyll, chlorophyllin, hydrogenated cottonseed oil, chlorine dioxide, beta cyclodextrin, zeolite, silica-based material, carbon-based material, enzymes such as laccase, and combinations thereof. Breath fresheners can include essential oils as well as various aldehydes and alcohols. Essential oils used as breath fresheners can include oils of spearmint, peppermint, wintergreen, sassafras, chlorophyll, citral, geraniol, cardamom, clove, sage, carvacrol, eucalyptus, cardamom, magnolia bark extract, marjoram, cinnamon, lemon, lime, grapefruit, orange, and combinations thereof. Aldehydes such as cinnamic aldehyde and salicylaldehyde can be used. Additionally, chemicals such as menthol, carvone, iso-garrigol, and anethole can function as breath fresheners. The breath fresheners can be present in a suitable amount depending upon the desired level of intensity. In some embodiments, the breath fresheners are present in an amount of about 0.01 to about 2 weight percent of the confectionery composition. Within the range of about 0.01 to about 2 weight percent, the breath freshener amount can be about 0.05 to about 1.25 weight percent; specifically, about 0.1 to about 1 weight percent.

Exemplary mouth moisteners include saliva stimulators such as acids and salts including acetic acid, adipic acid, ascorbic acid, butyric acid, citric acid, formic acid, fumaric acid, glyconic acid, lactic acid, phosphoric acid, malic acid, oxalic acid, succinic acid, tartaric acid, and salts of the foregoing acids. The mouth moisteners can be present in a suitable amount depending upon the desired level of intensity. In some embodiments, the mouth moisteners are present in an amount of about 0.01 to about 2 weight percent of the confectionery composition. Within the range of about 0.01 to about 2 weight percent, the mouth moisteners amount can be about 0.05 to about 1.25 weight percent, specifically about 0.1 to 1 weight percent.

Similarly, humectants, which can provide a perception of mouth hydration, can be included. Such humectants can include glycerol, sorbitol, polyethylene glycol, erythritol, xylitol, and combinations thereof. Additionally, in some embodiments, fats can provide a perception of mouth moistening. Such fats can include medium chain triglycerides, vegetable oils, fish oils, mineral oils, and combinations thereof. The humectants can be present in a suitable amount depending upon the desired level of intensity. In some embodiments, the humectants are present in an amount of about 0.01 to about 2 weight percent of the confectionery composition. Within this range, the humectant amount can be about 0.05 to about 1.25 weight percent, specifically about 0.1 to 1 weight percent.

Suitable acidulants illustratively include acetic acid, citric acid, fumaric acid, hydrochloric acid, lactic acid, and nitric acid as well as sodium citrate, sodium bicarbonate, sodium carbonate, sodium or potassium phosphate, magnesium oxide, potassium metaphosphate, sodium acetate, and combinations thereof. The acidulants can be present in a suitable amount depending upon the desired level of intensity. In some embodiments, the acidulants are present in an amount of about 0.1 to about 3 weight percent of the confectionery composition. Within this range, the acidulant amount can be about 0.5 to about 2.5 weight percent, specifically about 0.75 to 2 weight percent. In some embodiments, the acidulants are encapsulated. Any food-grade encapsulated acidulant commercially available can be used. For example, encapsulated citric acid available from BALCHEM CONFECSHURE under trade name 396AD0A878, or encapsulated malic acid available from BALCHEM CONFECSHURE under trade name 573 AD0A878 can be used.

Exemplary buffering agents include sodium bicarbonate, sodium phosphate, sodium hydroxide, ammonium hydroxide, potassium hydroxide, sodium stannate, triethanolamine, citric acid, hydrochloric acid, sodium citrate, and combinations thereof. The buffering agents can be present in a suitable amount depending upon the desired level of intensity. In some embodiments, the buffering agents are present in an amount of about 0.01 to about 2 weight percent of the confectionery composition. Within this range, the buffering agent amount can be about 0.05 to about 1.25 weight percent, specifically about 0.1 to about 1 weight percent.

In some embodiments, a tingling sensation can be provided. Tingling agents include jambu, and alkylamides extracted from materials such as jambu or sanshool. Tingling agents can be present in a suitable amount depending upon the desired level of intensity. In some embodiments, the tingling agents are present in an amount of about 0.01 to about 2 weight percent of the confectionery composition. Within this range, the tingling agent amount can be about 0.05 to about 1.25 weight percent, specifically about 0.1 to 1 weight percent.

Suitable oral care agents include breath fresheners, tooth whiteners, antimicrobial agents, tooth mineralizers, tooth decay inhibitors, topical anesthetics, mucoprotectants, stain removers, oral cleaning agents, bleaching agents, desensitizing agents, dental remineralization agents, antibacterial agents, anticaries agents, plaque acid buffering agents, surfactants and anticalculus agents, and combinations thereof. Examples of such ingredients include, hydrolytic agents including proteolytic enzymes, abrasives such as hydrated silica, calcium carbonate, sodium bicarbonate and alumina, other active stain removing components such as surface-active agents, including anionic surfactants such as sodium stearate, sodium palminate, sulfated butyl oleate, sodium oleate, salts of fumaric acid, glycerol, hydroxylated lecithin, sodium lauryl sulfate and chelators such as polyphosphates, which are typically employed as tartar control ingredients. Oral care ingredients can also include tetrasodium pyrophosphate and sodium tri-polyphosphate, sodium bicarbonate, sodium acid pyrophosphate, xylitol, sodium hexametaphosphate, and combinations thereof.

In addition, suitable oral care agents include peroxides such as carbamide peroxide, calcium peroxide, magnesium peroxide, sodium peroxide, hydrogen peroxide, and peroxydiphospate, and combinations thereof. In some embodiments, potassium nitrate and potassium citrate are included. Other examples can include casein glycomacropeptide, calcium casein peptone-calcium phosphate, casein phosphopeptides, casein phosphopeptide-amorphous calcium phosphate (CPP-ACP), and amorphous calcium phosphate. Still other examples include papaine, krillase, pepsin, trypsin, lysozyme, dextranase, mutanase, glycoamylase, amylase, glucose oxidase, and combinations thereof.

Suitable oral care agents include surfactants that achieve increased prophylactic action and render the oral care ingredients more cosmetically acceptable. Surfactants used as oral care agents include detersive materials that impart to the composition detersive and foaming properties. Suitable surfactants include sodium stearate, sodium ricinoleate, sodium lauryl sulfate, water-soluble salts of higher fatty acid monoglyceride monosulfates, such as the sodium salt of the monosulfated monoglyceride of hydrogenated coconut oil fatty acids, higher alkyl sulfates such as sodium lauryl sulfate, alkyl aryl sulfonates such as sodium dodecyl benzene sulfonate, higher alkyl sulfoacetates, sodium lauryl sulfoacetate, higher fatty acid esters of 1,2-dihydroxy propane sulfonate, and the substantially saturated higher aliphatic acyl amides of lower aliphatic amino carboxylic acid compounds, such as those having 12 to 16 carbons in the fatty acid, alkyl or acyl radicals, and the like. Examples of the last mentioned amides are N-lauroyl sarcosine, and the sodium, potassium, and ethanolammonium salts of N-lauroyl sarcosine, N-myristoyl sarcosine, and N-palmitoyl sarcosine.

In addition to surfactants, oral care ingredients can include antibacterial agents such as triclosan, chlorhexidine, zinc citrate, silver nitrate, copper, limonene, cetyl pyridinium chloride, and combinations thereof.

Anticaries agents can include fluoride ion sources such as sodium fluoride, potassium fluoride, sodium fluorosilicate, ammonium fluorosilicate, sodium monofluorophosphate, stannous fluoride, potassium stannous fluoride, sodium hexafluorostannate, stannous chloro fluoride, and combinations thereof.

Further examples of anticaries agents are included in U.S. Pat. No. 5,227,154 to Reynolds, U.S. Pat. No. 5,378,131 to Greenberg, and U.S. Pat. No. 6,685,916 to Holme et al. Oral care agents can be present in a suitable amount depending upon the desired level of care. In some embodiments, the oral care agents are present in an amount of about 0.01 to about 2 weight percent of the confectionery composition. Within this range, the oral care agent amount can be about 0.05 to about 1.25 weight percent, specifically about 0.1 to about 1 weight percent.

Throat care or throat-soothing ingredients include analgesics, antihistamines, anesthetics, demulcents, mucolytics, expectorants, antitussives, antiseptics, and combinations thereof. In some embodiments, throat-soothing agents include honey, propolis, aloe vera, glycerine, menthol, or a combination thereof. Throat care agents can be present in a suitable amount depending upon the desired level of care. In some embodiments, the throat care agents are present in an amount of about 0.01 to about 2 weight percent of the confectionery composition. Within this range, the throat care agent amount can be about 0.05 to about 1.25 weight percent, specifically about 0.1 to about 1 weight percent.

Medicaments can be included in the confectionery composition. Non-limiting illustrative categories and specific examples include antihistamines, decongestants (sympathomimetics), antitussives (cough suppressants), expectorants, anesthetics, analgesics, demulcents, antibacterial agents, antiviral agents, anti-inflammatories, antacids, antifungal agents, chemotherapeutics, diuretics, psychotherapeutic agents, homeopathic agents, anticholinergics, throat-soothing agents, antinauseants, cardiovascular agents, various alkaloids, laxatives, appetite suppressants, ACE-inhibitors, anti-asthmatics, anti-cholesterolemics, anti-depressants, anti-diarrhea preparations, anti hypertensives, anti-lipid agents, acne drugs, amino acid preparations, anti-uricemic drugs, anabolic preparations, appetite stimulants, bone metabolism regulators, contraceptives, endometriosis management agents, enzymes, erectile dysfunction therapies such as sildenafil citrate, fertility agents, gastrointestinal agents, homeopathic remedies, hormones, motion sickness treatments, muscle relaxants, osteoporosis preparations, oxytocics, parasympatholytics, parasympathomimetics, prostaglandins, respiratory agents, sedatives, smoking cessation aids such as bromocryptine or nicotine, tremor preparations, urinary tract agents, anti-ulcer agents, anti-emetics, hyper- and hypo glycemic agents, thyroid and anti-thyroid preparations, terine relaxants, erythropoietic drugs, mucolytics, DNA and genetic modifying drugs, and nutritional supplements, including nutraceuticals, micronutrients, vitamins and co-enzymes. The pharmaceutically acceptable salts and prodrugs of the medicaments are also included unless specified otherwise. Some of these medicaments can serve more than one purpose. Combinations of the foregoing types of optional medicaments can be used. Two or more medicaments that have activity against the same or different symptoms can be used together in a combination.

Medicaments for the treatment of a cough, or a cold or flu symptom include elements, compounds or materials, alone or in combination, that have been used for, or have been shown to be useful for, the amelioration of at least one symptom commonly associated with cough, colds, or influenza. It is to be understood that a “medicament for the treatment of a cough, or a cold or flu symptom” includes medicaments that are also useful for the treatment of cold-like or flu-like symptoms arising from other sources, such as allergies, adverse environmental conditions, and the like. Cold, cold-like, flu, and flu like symptoms as used herein include cough, coryza, nasal congestion, upper respiratory infections, allergic rhinitis, otitis, sinusitis, sneezing, and the discomfort, pain, fever and general malaise associated with colds, flu, allergies, adverse environmental conditions, and the like.

Examples of general categories of medicaments for the treatment of a cough, or a cold or flu symptom include antihistamines, decongestants (sympathomimetics), antitussives (cough suppressants), anti-inflammatories, homeopathic agents, expectorants, anesthetics, demulcents, analgesics, anticholinergics, throat-soothing agents, antibacterial agents, and antiviral agents. Some of these medicaments can serve more than one purpose. The pharmaceutically acceptable salts and pro drugs of the medicaments are also included unless specified otherwise. Two or more medicaments that have activity against the same or different symptoms of colds or coughs can be used together in a combination.

Exemplary antihistamines include azatadine, bromodiphenhydramine, brompheniramine, brompheniramine maleate, carbinoxamine, carbinoxamine maleate, cimetidine, chlorpheniramine, chlorpheniramine maleate, dexchlorpheniramine, diphenhydramine, diphenhydramine hydrochloride, doxylamine, phenindamine, pheniramine, phenyltoloxamine, pyrilamine, promethazine, triprolidine, loratadine, ranitidine, chlorcyclizine, terfenadine, clemastine fumarate, dimenhydrinate, prilamine maleate, tripelennamine hydrochloride, tripelennamine citrate, hydroxyzine pamoate, hydroxyzine hydrochloride, cyclizine lactate, cyclizine hydrochloride, meclizine hydrochloride, acrivastine, cetirizine hydrochloride, astemizole, levocabastine hydrochloride, cetirzine, and combinations thereof.

Exemplary decongestants include agents such as levopropoxyphene napsylate, noscapine, carbetapentane, caramiphen, chlophedianol, pseudoephedrine hydrochloride, phenylephrine, phenylpropanolamine, diphenhydramine, glaucine, pholcodine, benzonatate, ephedrine, ephinephrine, levodesoxyephedrine, oxymetazoline, naphazoline, propylhexedrine, xylometazoline, and combinations thereof.

Antitussives help relieve coughing. Examples of antitussives include codeine, dihydrocodeine, hydrocodone and hydromorphone, carbetapentane, caramiphen, hydrocodone bitartrate, chlorphedianol, noscarpine, dextromethorphan, and combinations thereof.

Expectorants include guaifenesin, aniseed, blood root, coltsfoot, elderflower, golden seal, grindelia, hyssop, lungwort, mullein, senega, thuja, thyme, vervain, glyceryl guaiacolate, terpin hydrate, N-acetylcysteine, bromhexine, ambroxol, domiodol, 3-iodo-1,2-propanediol and wild cherry, ammonium chloride, calcium iodide, iodinated glycerol, potassium guaiacolsulfonate, potassium iodide, sodium citrate, and combinations thereof.

Anaesthetics include etomidate, ketamine, propofol, and benodiazapines (e.g., chlordiazepoxide, diazepam, clorezepate, halazepam, flurazepam, quazepam, estazolam, triazolam, alprozolm, midazolam, temazepam, oxazepam, lorazepam), benzocaine, dyclonine, bupivacaine, etidocaine, lidocaine, mepivacaine, promoxine, prilocaine, procaine, proparcaine, ropivacaine, tetracaine, and combinations thereof. Other useful agents can include amobartital, aprobarbital, butabarbital, butalbital mephobarbital, methohexital, pentobarbital, phenobarbital, secobarbital, thiopental, paral, chloral hydrate, ethchlorvynol, clutethimide, methprylon, ethinamate, meprobamate, and combinations thereof.

Analgesics include opioids such as morphine, mepidine, dentanyl, sufentranil, alfentanil, aspirin, salicylamide, sodium salicylate, acetaminophen, ibuprofen, indomethacine, naproxen, atrin, isocome, midrin, axotal, firinal, phrenilin, ergot and ergot derivatives (wigraine, cafergot, ergostat, ergomar, dihydroergotamine), imitrex, and combinations thereof.

Anticholinergics include homatropine, atropine, scopolamine hydrogen bromide, L-hyoscyamine, L-alkaloids of belladonna, tincture of belladonna alkaloids, homatropine hydrogen bromide, homatropine methylbromide, methscopolamine, anisotropine, anisotropine with phenobarbital, clindinium, glycopyrrolate, hexocyclim, isopropamide, mepenzolate, methantheline, oxyphencyclimine, propantheline, tridihexethyl, dicyclomine, scopolamine, atropine, dicyclomine, flavoxate, ipratropium, oxybutynin, pirenzepine, tiotropium, tolterodine, tropicamide, trimethaphan, atracurium, doxacurium, mivacurium, pancuronium, tubocurarine, vecuronium, suxamethonium chloride, and combinations thereof.

Demulcents include coltsfoot, comfrey, corn silk, couchgrass, flaxseed, irish moss, lungwort, liquorice, mallow, marshmallow, mullein, oatmeal, parsley piert, slippery elm, and combinations thereof.

Antibacterial agents include those within the antibiotic classes of aminoglycosides, cephalosporins, macrolides, penicillins, quinolones, sulfonamides, and tetracyclines. Specific exemplary antibiotic agents include naficillin, oxacillin, vancomycin, clindamycin, erythromycin, trimethoprim-sulphamethoxazole, rifampin, ciprofloxacin, broad spectrum penicillin, amoxicillin, gentamicin, ceftriazoxone, cefotaxime, chloramphenicol, clavunate, sulbactam, probenecid, doxycycline, spectinomycin, cefixime, penicillin G, minocycline, β-lactamase inhibitors; meziocillin, piperacillin, aztreonam, norfloxacin, trimethoprim, ceftazidime, dapsone, neomycin, azithromycin, clarithromycin, amoxicillin, ciprofloxacin, and vancomycin.

Antiviral agents specifically or generally modulate the biological activity of viruses such as picornavirus, influenza virus, herpes viruses, herpes simplex, herpes zoster, enteroviruses, varicella and rhinovirus, which are associated with the common cold. Exemplary antiviral agents include acyclovir, trifluridine, idoxorudine, foscarnet, ganciclovir, zidovudine, dideoxycytosine, dideoxyinosine, dipyridamole, stavudine, cidofovir, famciclovir, valaciclovir, valganciclovir, acyclovir, didanosine, zalcitabine, rifimantadine, saquinavir, indinavir, ritonavir, ribavarin, nelfinavir, adefovir, nevirapine, delavirdine, efavirenz, abacavir, amantadine, emtricitabine, entecavir, tenofovir, zanamivir, oseltamivir, impulsin, pleconaril, penciclovir, vidarabine, cytokines,and combinations thereof.

Anti-inflammatories include salicylic acid derivatives including aspirin, paraminophenol derivatives including acetaminophen, indole and indene acetic acids including indomethacin, sulindac and etodalac, heteroaryl acetic acids including tolmetin diclofenac and ketorolac, aryl propionic acid derivatives including ibuprofen, naproxen, ketoprofen, fenopren, ketorlac, carprofen, oxaprozine, anthranilic acids including mefenamic acid, meclofenamic acid, and enolic acids including piroxicam, tenoxicam, phenylbutazone and oxyphenthatrazone.

Antacids include cimetidine, ranitidine, nizatidine, famotidine, omeprazole, bismuth antacids, metronidazole antacids, tetracycline antacids, clarthromycin antacids, hydroxides of aluminum, magnesium, sodium bicarbonates, calcium bicarbonate and other carbonates, silicates, phosphates, and combinations thereof.

Antifungal agents include, for example, ketoconazole, fluconazole, nystatin, itraconazole, clomitrazole, natamycin, econazole, isoconazole, oxiconazole, thiabendazole, tiaconazole, voriconazole, terbinafine, amorolfine, micfungin, amphotericin B, and combinations thereof.

Chemotherapeutics agents include cisplatin (CDDP), procarbazine, mechlorethamine, cyclophosphamide, camptothecin, ifosfamide, melphalan, chlorambucil, bisulfan, nitrosurea, dactinomycin, daunorubicin, doxorubicin, bleomycin, plicomycin, mitomycin, etoposide (VP16), tamoxifen, taxol, transplatinum, 5-fluorouracil, vincristin, vinblastin and methotrexate and analogs or derivative variants thereof, and combinations thereof.

Diuretics include but are not limited to acetazolamide, dichlorphenamide, methazolamide, furosemide, bumetanide, ethacrynic acid torseimde, azosemide, muzolimine, piretanide, tripamide, bendroflumethiazide, benzthiazide, chlorothiazide, hydrochlorothiazide, hydroflumethiazide, methyclothiazide, polythiazide, trichlormethiazide, indapamide, metolazone, quinethazone, amiloride, triamterene, sprionolactone, canrenone, potassium canrenoate, and combinations thereof.

Psychotherapeutic agents include thorazine, serentil, mellaril, millazine, tindal, permitil, prolixin, trilafon, stelazine, suprazine, taractan, navan, clozaril, haldol, halperon, loxitane, moban, orap, risperdal, alprazolam, chlordiaepoxide, clonezepam, clorezepate, diazepam, halazepam, lorazepam, oxazepam, prazepam, buspirone, elvavil, anafranil, adapin, sinequan, tofranil, surmontil, asendin, norpramin, pertofrane, ludiomil, pamelor, vivactil, prozac, luvox, paxil, zoloft, effexor, welibutrin, serzone, desyrel, nardil, parnate, eldepryl, and combinations thereof.

Appetite suppressants include benzphetamine, diethylpropion, mazindol, phendimetrazine, phentermine, hoodia, ephedra, and caffeine. Additional appetite suppressant are commercially under the following trade names: Adipex, Adipost, Bontril PDM, Bontril Slow Release, Didrex, Fastin, Ionamin, Mazanor, Melfiat, Obenix, Phendiet, Phendiet-105, Phentercot, Phentride, Plegine, Prelu-2, Pro-Fast, PT 105, Sanorex, Tenuate, Sanorex, Tenuate, Tenuate Dospan, Tepanil Ten-Tab, Teramine, Zantryl and combinations thereof.

Nutraceuticals and micronutrients include herbs and botanicals such as aloe, bilberry, bloodroot, calendula, capsicum, chamomile, cat's claw, echinacea, garlic, ginger, ginko, goldenseal, various ginseng, green tea, golden seal, guarana, kava kava, lutein, nettle, passionflower, rosemary, saw palmetto, St. John's wort, thyme, valerian, and combinations thereof. Also included are mineral supplements such as calcium, copper, iodine, iron, magnesium, manganese, molybdenum, phosphorus, zinc, selenium, and combinations thereof. Other nutraceuticals that can be added include fructo-oligosaccharides, glucosamine, grapeseed extract, cola extract, guarana, ephedra, inulin, phytosterols, phytochemicals, catechins, epicatechin, epicatechin gallate, epigallocatechin, epigallocatechin gallate, isoflavones, lecithin, lycopene, oligofructose, polyphenols, flavanoids, flavanols, flavonols, and psyllium as well as weight loss agents such as chromium picolinate and phenylpropanolamine. Vitamins and co-enzymes include water or fat-soluble vitamins such as thiamin, riboflavin, nicotinic acid, pyridoxine, pantothenic acid, biotin, folic acid, flavin, choline, inositol and paraminobenzoic acid, carnitine, vitamin C, vitamin D and its analogs, vitamin A and the carotenoids, retinoic acid, vitamin E, vitamin K, vitamin B6, vitamin B12, and combinations thereof. Combinations comprising at least one of the foregoing nutraceuticals can be used.

Specific optional, additional medicaments that can be used include caffeine, cimetidine, ranitidine, famotidine, omeprazole, dyclonine, nicotine, and combinations thereof.

The medicaments can be present in a suitable amount depending upon the suitable level of dosage for the desired purpose. In some embodiments, the medicaments are present in an amount of about 0.01 to about 2 weight percent of the confectionery composition. Within this range, the medicament amount can be about 0.05 to about 1.25 weight percent, specifically about 0.1 to about 1 weight percent.

Antioxidants include natural and artificial antioxidants like beta-carotenes, acidulants (e.g. Vitamin C), propylgallate, butylated hydroxyanisole, butylated hydroxytoluene, Vitamin E, Carnosic acid, Rosmanol, rosmaridiphenol, and combinations thereof. The antioxidants can be present in a suitable amount depending upon the desired purpose. In some embodiments, the antioxidants are present in an amount of about 0.01 to about 2 weight percent of the confectionery composition. Within the range of about 0.01 to about 2 weight percent, the antioxidant amount can be about 0.05 to about 1.25 weight percent, specifically about 0.1 to about 1 weight percent.

Preservatives include any natural and synthetic preservatives that improve shelf life of the confectionery composition. Suitable preservatives include propanoic acid, benzoic acid, and sorbic acid.

The relative amounts of each of the components of the confectionery composition will depend on the identity of the particular component of the confectionery composition, as well as, the desired flavor of the confectionery composition, and are readily determined by one of ordinary skill in the art.

In some embodiments, the confectionery composition further comprises an emulsifier. In some embodiments, the emulsifier is selected from the group consisting glyceryl monostearate, lecithin, a fatty acid monoglyceride, a diglyceride, propylene glycol monostearate, and a combination thereof. In some embodiments, the emulsifier is selected from the group consisting glyceryl monostearate, lecithin, and combinations thereof.

Advantageously, the emulsifier may comprise sugar esters, polyglycerol fatty acid esters, polyglycerol polyricinoleate (PGPR), polysorbates (polyoxyethylene sorbitan esters), monoglycerides and combinations thereof. Preferred emulsifiers are sugar esters or polyglycerol polyricinoleate (PGPR). In some embodiments, a hydrophilic emulsifier is used in combination with any other emulsifier cited above. In some embodiments, sodium stearoyl lactylate (SSL) is used in combination with sugar esters or PGPR.

In some embodiments, lecithin and glyceryl monostearate are used in a weight ratio of about 1:5 to about 1:7.

In some embodiments, the emulsifier is present in an amount of about 0.1 to about 1.0 weight percent, based on the weight of the confectionery composition. In some embodiments, the confectionery composition comprises lecithin in an amount of about 0.001 to about 0.1 weight percent, and glyceryl monostearate in an amount of about 0.01 to about 0.7 weight percent.

In some embodiments, the confectionery composition comprises an emulsifier and a texturizing agent, wherein the weight ratio of the emulsifier to the texturizing agent is about 1:6 to about 1:9.

The invention includes at least the following embodiments.

Embodiment 1: A method of forming a confectionery composition, comprising: blending components comprising about 35 to about 95 weight percent of a polyglucitol having a degree of polymerization of at least 3, and about 5 to about 13 weight percent water, at a temperature of about 50° C. to about 85° C. to form a confectionery composition; wherein the confectionery composition retains at least 90 percent of the added water; and wherein all weight percents are based on the weight of the confectionery composition, unless another basis is specified.

Embodiment 2: The method of embodiment 1, wherein said polyglucitol has the structure

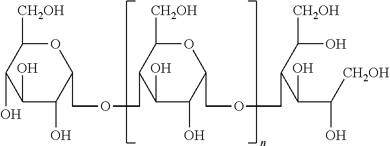

wherein n is at least 1.

Embodiment 3: The method of embodiment 1 or 2, wherein said forming the confectionery composition is conducted entirely at temperatures less than or equal to 85° C.

Embodiment 4: The method of any of embodiments 1-3, wherein said forming the confectionery composition is conducted entirely at a pressure of about 90 to about 110 kilopascals.

Embodiment 5: The method of any of embodiments 1-4, wherein said confectionery composition is substantially free of gum arabic, carrageenan, locust bean gum, guar gum, and gelatin.

Embodiment 6: The method of any of embodiments 1-5, wherein the confectionery composition comprises no more than 10 weight percent sorbitol.

Embodiment 7: The method of any of embodiments 1-6, wherein the confectionery composition comprises no more than 20 weight percent sorbitol, based on the weight of the polyglucitol.

Embodiment 8: The method of any of embodiments 1-7, wherein the confectionery composition comprises no more than 20 weight percent maltitol.

Embodiment 9: The method of any of embodiments 1-8, wherein the confectionery composition comprises no more than 30 weight percent maltitol, based on the weight of the polyglucitol.

Embodiment 10: The method of any of embodiments 1-9, wherein the amount of the polyglucitol is at least 50 weight percent of the total of sorbitol, maltitol, and the polyglucitol.

Embodiment 11: The method of any of embodiments 1-10, wherein the blended components comprise about 70 to about 95 weight percent of the polyglucitol.

Embodiment 12: The method of any of embodiments 1-11, wherein the blended components further comprise about 0.5 to about 2 weight percent of an edible fat or oil.

Embodiment 13: The method of any of embodiments 1-12, wherein (a) about 30 to about 70 weight percent of the polyglucitol is provided in the form of a powdered polyglucitol composition comprising, based on the weight of the powdered polyglucitol composition, about 50 to about 99 weight percent polyglucitol having a degree of polymerization of at least 3, and less than or equal to 1 weight percent water; and (b) about 30 to about 70 weight percent of the polyglucitol is provided in the form of a liquid polyglucitol composition comprising, based on the weight of the liquid polyglucitol composition, about 30 to about 80 weight percent polyglucitol having a degree of polymerization of at least 3, and about 20 to about 40 weight percent water.

Embodiment 14: The method of any of embodiments 1-13, wherein the blended components comprise about 35 to about 50 weight percent of the polyglucitol; and wherein the blended components further comprise about 35 to about 55 weight percent of a polyol selected from the group consisting of sorbitol, mannitol, erythritol, xylitol, maltitol, isomalt, and combinations thereof.

Embodiment 15: The method of any of embodiments 1-14, wherein the blended components further comprise about 1 to about 10 weight percent of an edible fat or oil.

Embodiment 16: The method of any of embodiments 1-15, wherein the blended components further comprise about 0.3 to about 3 weight percent of sodium bicarbonate, potassium bicarbonate, or a combination thereof; and about 0.3 to about 2.5 weight percent of a food-grade acid.

Embodiment 17: The method of any of embodiments 1-16, wherein the blended components further comprise about 1 to about 5 weight percent of a foaming agent.

Embodiment 18: The method of any of embodiments 1-17, wherein the blended components further comprise about 0.5 to about 10 weight percent of a hydrocolloid.

Embodiment 19: The method of any of embodiments 1-18, wherein the forming the confectionery composition is conducted entirely at temperatures less than or equal to 85° C.; wherein the blended components comprise about 70 to about 95 weight percent of the polyglucitol; wherein the confectionery composition comprises less than or equal to 10 weight percent sorbitol; wherein the confectionery composition comprises less than or equal to 20 weight percent maltitol; wherein the amount of the polyglucitol is at least 60 weight percent of the total of sorbitol, maltitol, and polyglucitol; wherein the blended components further comprise about 0.5 to about 2 weight percent of an edible fat or oil; and wherein the blended components are substantially free of gum arabic, carrageenan, locust bean gum, guar gum, and gelatin.

Embodiment 20: The method of any of embodiments 1-19, wherein the forming the confectionery composition is conducted entirely at temperatures less than or equal to 85° C.; wherein the polyglucitol is provided in the form of a blend of about 30 to about 70 weight percent of a powdered polyglucitol composition comprising, based on the weight of the powdered polyglucitol composition, about 50 to about 99 weight percent polyglucitol having a degree of polymerization of at least 3, and less than or equal to 1 weight percent water, and about 30 to about 70 weight percent of a liquid polyglucitol composition comprising based on the weight of the liquid polyglucitol composition, about 30 to about 80 weight percent polyglucitol having a degree of polymerization of at least 3, and about 20 to about 40 weight percent water; wherein the blended components further comprise about 35 to about 55 weight percent of a polyol selected from the group consisting of sorbitol, mannitol, erythritol, xylitol, maltitol, isomalt, and combinations thereof; and wherein the blended components further comprise about 1 to about 10 weight percent of an edible fat or oil.

Embodiment 21: A confectionery composition prepared by the method of any of embodiments 1-20.

Embodiment 22: A confectionery composition, comprising: about 70 to about 95 weight percent of a polyglucitol having a degree of polymerization of at least 3; and about 5 to about 10 weight percent water.

Embodiment 23: The confectionery composition of embodiment 22,; wherein the confectionery composition comprises less than or equal to 10 weight percent sorbitol; wherein the confectionery composition comprises less than or equal to 20 weight percent maltitol; wherein the amount of the polyglucitol is at least 60 weight percent of the total of sorbitol, maltitol, and polyglucitol; and wherein the confectionery composition further comprise about 0.5 to about 2 weight percent of an edible fat or oil.

Embodiment 24: A confectionery composition comprising about 35 to about 50 weight percent of the a polyglucitol having a degree of polymerization of at least 3; about 35 to about 55 weight percent of a polyol selected from the group consisting of sorbitol, mannitol, erythritol, xylitol, maltitol, isomalt, and combinations thereof; about 5 to about 10 weight percent water, wherein the confectionery composition further comprise about 1 to about 10 weight percent of an edible fat or oil.

Embodiment 25: A confectionery article, comprising: a first layer comprising a chewing gum composition; and a second layer disposed on the first layer; wherein the second layer comprises a confectionery composition comprising, based on the weight of the confectionery composition, about 35 to about 95 weight percent of a polyglucitol, and about 5 to about 10 weight percent water.

Embodiment 26: A chewing gum composition, comprising a gum base; and a confectionery composition prepared by the method of any of Embodiments 1-20.

Embodiment 27: A chewing gum composition, comprising a gum base; and a confectionery composition, comprising about 35 to about 95 weight percent of a polyglucitol having a degree of polymerization of at least 3; and about 5 to about 10 weight percent water, wherein the gum base and the confectionery composition are homogenously mixed together.

Embodiment 28: The method of any of embodiments 1-20, wherein the confectionery composition is selected from the group consisting of hard candy, soft candy, chewy candy, lozenge, toffees, fudges, fondants, jellies, gummies, pastilles, caramels, taffies, nougats, chewing gums, and combinations thereof.

The invention is further illustrated by the following non-limiting examples.

### EXAMPLE 1

### Mint Flavored Hard Candy

This example demonstrates the preparation of mint-flavored hard candy. The composition of Example 1 hard candy is summarized in Table 1, where component amounts are expressed in weight percent based on the total weight of the confectionery composition. The component designated “polyglucitol powder” in Table 1 was Roquette POLYSORB® 96/02/01 having 1 weight percent maltitol, 2 weight percent sorbitol, and 96 weight percent of polyglucitol. Further, in Table 1, “fat” was hydrogenated cottonseed oil having a melting point of about 45° C.

TABLE 1

| | Amounts |
|---|---|
| Components | (in weight percentages) |
| Polyglucitol powder | 90.09 |
| Water | 7.83 |
| Fat | 1.25 |
| Mint Flavor | 0.24 |
| Menthol | 0.35 |
| Acesulfame K | 0.08 |
| Aspartame | 0.16 |

To prepare the hard candy, a mixing kettle with a Z-arm type mixer was heated to 75° C. Water, which had been pre-heated to 75° C., was added to the mixer. The polyglucitol powder was added to the mixer in small portions, blending each portion to wet the added polyglucitol before adding the next portion. The resulting mixture was mixed well, yielding a homogeneous mass. Pre-melted fat was added to the homogenous mixture and was further mixed to yield another apparently homogeneous mixture. The mixture was cooled. Flavors and sweeteners were added as the mass started to become viscous (at about 40° C.). The composition was discharged from the mixing kettle and formed into candy pieces on hand drop rolls.

### EXAMPLE 2

### Lemon Flavored Hard Candy

This example demonstrates the preparation of lemon-flavored hard candy. The composition of Example 2 hard candy is summarized in Table 2, where component amounts are expressed in weight percent based on the total weight of the confectionery composition. The component designated “polyglucitol powder” in Table 2 was Roquette POLYSORB 96/02/01. Further, in Table 2, “Fat” was hydrogenated cottonseed oil having a melting point of about 45° C., the lemon flavor was Lemon N&A 333240 25AH commercially available from Firmenich Inc., USA.

TABLE 2

| | Amounts |
|---|---|
| Components | (in weight percentages) |
| Polyglucitol powder | 90.08 |
| Water | 7.83 |
| Fat | 1.00 |
| Menthol | 0.10 |
| Lemon flavor | 0.24 |
| Citric acid | 0.50 |
| Sucralose | 0.25 |

To prepare the confectionery composition, a mixing kettle with a Z-arm type mixer was heated to 75° C. Water, which had been pre-heated to 75° C., was added to the mixer. The polyglucitol powder was added to the mixer in small portions, blending each portion to wet the added polyglucitol before adding the next portion. The resulting mixture was mixed well, yielding a homogeneous mass. Pre-melted fat was added to the homogenous mixture and was further mixed to yield another apparently homogeneous mixture. The mixture was cooled, and flavors, citric acid, and sweeteners were added as the mass started to become viscous (at about 40° C.). The composition was discharged from the mixing kettle and formed into candy pieces on hand drop rolls.

### EXAMPLE 3

### Orange Flavored Chewy Candy

This example demonstrates the preparation of an orange-flavored chewy candy. The composition is summarized in Table 3. The polyglucitol powder was Roquette POLYSORB 96/02/01. The “bulking agent” was isomalt having a particle size less than or equal to 25 micrometers. The “fat” was hydrogenated cottonseed oil having a melting point of 45° C., and the orange flavor was Orange N&A 540507A (758908 17501A) commercially available from Firmenich Inc., USA.

TABLE 3

| | Amounts |
|---|---|
| Components | (in weight percentages) |
| Polyglucitol powder | 36.00 |
| Bulking agent | 49.88 |
| Water | 7.50 |
| Fat | 5.00 |
| Color (yellow #6) | 0.02 |
| Orange flavor | 0.30 |
| Sucralose | 0.30 |
| Citric acid | 1.00 |

To prepare the confectionery composition, a mixing kettle with a Z-arm type mixer was heated to 60° C. The polyglucitol and bulking agent were added to the kettle and mixed. Water was added and mixed to yield a homogeneous mass. Color was added and the resulting mixture was mixed. Pre-melted fat was added, and the resulting mixture was mixed until a homogeneous mixture was formed. The mixture was cooled, and flavor, citric acid, and sweetener were added as the mass started to become viscous (at about 40° C.). The composition was discharged from the kettle and formed into candy pieces, which were wrapped to protect from cold flow.

### EXAMPLE 4

### Orange Flavored Chewy Candy

This example demonstrates the preparation of another orange-flavored chewy candy. The composition is summarized in Table 4. The polyglucitol powder was Roquette POLYSORB 96/02/01. The “bulking agent” was isomalt having a particle size less than or equal to 25 micrometers. The “fat” was hydrogenated coconut oil having a melting point of 45° C., and the orange flavor was Orange N&A 540507A (758908 17501A) commercially available from Firmenich Inc., USA.

TABLE 4

| | Amounts |
|---|---|
| Components | (in weight percentages) |
| Polyglucitol powder | 36.00 |
| Bulking agent | 49.55 |
| Water | 6.50 |
| Glycerin | 0.35 |
| Fat | 5.00 |
| Color (yellow #6) | 0.02 |
| Orange flavor | 0.30 |
| Sucralose | 0.30 |
| Citric acid | 1.00 |

To prepare the confectionery composition, a mixing kettle with a Z-arm type mixer was heated to 60° C. The polyglucitol powder and bulking agent were added to the kettle and mixed. Water was added and mixed to yield a homogeneous mass. Glycerin and color were added and the resulting mixture was mixed. Pre-melted fat was added, and the resulting mixture was mixed until a homogeneous mixture was formed. The mixture was cooled, and flavors and sweeteners were added as the mass started to become viscous (at about 40° C.). The composition was discharged from the kettle and formed into candy pieces, which were wrapped to protect from cold flow.

### EXAMPLE 5

### Lemon-Flavored Chewy Candy

This example demonstrates the preparation of an “aerated” (gasified) lemon-flavored chewy candy. The composition is summarized in Table 5. Components are listed as parts by weight. The polyglucitol powder was STABILIT SD30 available from Corn Products International Inc. The “bulking agent” was isomalt having a particle size less than or equal to 25 micrometers. The “fat” was hydrogenated coconut oil having a melting point of 45° C., and the lemon flavor was Lemon N&A 333240 25AH commercially available from Firmenich Inc., USA.

TABLE 5

| | Amounts |
|---|---|
| Components | (in weight percentages) |
| Polyglucitol powder | 38.50 |
| Bulking agent | 46.18 |
| Water | 6.50 |
| Fat | 5.00 |
| Sodium bicarbonate | 1.50 |
| Citric acid | 1.00 |
| Color (yellow #5) | 0.02 |
| Lemon flavor | 0.30 |
| Sucralose | 0.30 |
| Citric acid | 1.00 |

To prepare the confectionery composition, a mixing kettle with a Z-arm type mixer was heated to 60° C. The polyglucitol and bulking agent were added to the kettle and mixed. Water was added, and mixed to yield a homogeneous mass. Color was added and the resulting mixture was mixed. Pre-melted fat at 60 ° C. was added, and the resulting mixture was mixed until a homogeneous mixture was formed. Sodium bicarbonate and 1.00 gram of citric acid were dry blended, then added to the mixing kettle, and the resulting mixture was mixed, causing the formation of carbon dioxide bubbles. The mixture was cooled, and flavors (including the remaining 1.00 gram of citric acid) and sweeteners were added as the mass started to become viscous (at about 40° C.). The composition was discharged from the kettle and formed into candy pieces, which were wrapped to protect from cold flow.

### EXAMPLE 6

### Lemon-Flavored Chewy Candy

This example demonstrates the preparation of an “aerated” (gasified) lemon-flavored chewy candy incorporating gluten. The composition is summarized in Table 6. Components are listed as parts by weight. The polyglucitol powder was STABILIT SD30 available from Corn Products International Inc. The “bulking agent” was isomalt having a particle size less than or equal to 25 micrometers. The “fat” was hydrogenated coconut oil having a melting point of 45° C., and the lemon flavor was Lemon N&A 333240 25AH commercially available from Firmenich Inc., USA.

TABLE 6

| | Amounts |
|---|---|
| Components | (in weight percentages) |
| Polyglucitol powder | 38.50 |
| Bulking agent | 40.18 |
| Gluten | 6.00 |
| Water | 6.50 |
| Fat | 5.00 |
| Sodium bicarbonate | 1.50 |
| Citric acid | 1.00 |
| Color (yellow #5) | 0.02 |
| Lemon flavor | 0.30 |
| Sucralose | 0.30 |
| Citric acid | 1.00 |

To prepare the confectionery composition, a mixing kettle with a Z-arm type mixer was heated to 60° C. The polyglucitol, gluten, and bulking agent were added to the kettle and mixed. Water was added, and mixed to yield a homogeneous mass. Color was added and the resulting mixture was mixed. Pre-melted fat was added, and the resulting mixture was mixed until a homogeneous mixture was formed. Sodium bicarbonate and 1.00 gram of citric acid were dry blended, then added to the mixing kettle, and the resulting mixture was mixed, causing the formation of carbon dioxide bubbles. The mixture was cooled, and flavors, sweeteners, and the remaining citric acid were added as the mass started to become viscous (at about 40° C.). The composition was discharged from the kettle and formed into candy pieces, which were wrapped to protect from cold flow.

### EXAMPLE 7

### Orange-Flavored Chewy Candy

This example demonstrates the preparation of an “aerated” (gasified) orange-flavored chewy candy incorporating gelatin. The composition is summarized in Table 6, where “gelatin solution (40%)” refers to a 40 weight percent gelatin solution in water. The polyglucitol powder was Roquette POLYSORB 96/02/01. The “bulking agent” was maltitol. The “fat” was hydrogenated coconut oil having a melting point of 45° C., and the orange flavor was Orange N&A 540507A (758908 17501A) commercially available from Firmenich Inc., USA.

TABLE 7

| | Amounts |
|---|---|
| Components | (in weight percentages) |
| Polyglucitol powder | 38.50 |
| Bulking agent | 41.18 |
| Gelatin solution (40%) | 5.00 |
| Water | 6.50 |
| Fat | 5.00 |
| Sodium bicarb. | 1.50 |
| Citric acid | 1.00 |
| Color (yellow #6) | 0.02 |
| Orange flavor | 0.30 |
| Citric acid | 1.00 |

To prepare the confectionery composition, a mixing kettle with Z-arm type mixer was heated to 60° C. The polyglucitol and bulking agent were added to the kettle and mixed. Water was added, and mixed to yield a homogeneous mass. Pre-hydrated gelatin was added to the homogenous mass. Color was added and the resulting mixture was mixed. Pre-melted fat was added, and the resulting mixture was mixed until a homogeneous mixture was formed. Sodium bicarbonate and 1.00 gram of citric acid were dry blended, then added to the mixing kettle, and the resulting mixture was mixed, causing the formation of carbon dioxide bubbles. The mixture was cooled, and flavors, sweeteners, and the remaining citric acid were added as the mass started to become viscous (at about 40° C.). The composition was discharged from the kettle and formed into candy pieces, which were wrapped to protect from cold flow.

### EXAMPLE 8

### Chewy Candy

This example demonstrates the preparation of chewy candy composition incorporating a blend of liquid and powdered polyglucitol components. The composition is summarized in Table 8, where “polyglucitol liquid” was Roquette Polysorb® 75/08/22 comprising 6 weight percent sorbitol, 20 weight percent maltitol, and 74 weight percent of polyglucitol, on dry weight basis. The polyglucitol powder was Polysorb® 96/02/01. Also in Table 8, “foam booster” was cappuccino foam booster obtained from Kraft Foods Inc. The flavor was Orange N&A 540507A (758908 17501A) commercially available from Firmenich Inc., USA. Trucal D7® is a calcium source available from Glanbia PLC, Ireland.

TABLE 8

| | Amounts |
|---|---|
| Components | (in weight percentages) |
| Polyglucitol liquid | 32.00 |
| Polyglucitol powder | 49.87 |
| Gluten | 7.00 |
| Glycerin | 2.00 |
| Fat | 5.00 |
| Color | 0.03 |
| Flavor | 0.38 |
| Sucralose | 0.28 |
| Citric acid | 0.94 |
| Trucal D7 ® | 1.00 |
| Foam booster | 1.50 |

To prepare the confectionery composition, a mixing kettle with Z-arm type mixer was heated to 60° C. Pre-heated liquid polyglucitol at 60° C. was added to the mixing kettle. Powder polyglucitol and gluten were added to the kettle and mixed. Water was added, and mixed to yield a homogeneous mass. Glycerin was added to the homogenous mass and mixed. Color was added and the resulting mixture was mixed. Pre-melted fat was added and mixed until a homogeneous mixture was formed. The mixture was allowed to cool, and then flavor, acid, and sweetener were added as the mass started to become viscous (at about 40° C.). Trucal D7® (calcium source available from Glanbia Nutritionals PLC) and cappuccino foam booster (available from Kraft Foods Inc.) were added to the viscous mass and mixed. The composition was discharged from the kettle and formed into candy pieces, which were wrapped in a plastic wrapping paper to protect from cold flow.

### EXAMPLE 9

### Chewy Candy

This example demonstrates the preparation of chewy candy composition incorporating a blend of liquid and powdered polyglucitol components. The composition is summarized in Table 9, where “polyglucitol liquid” was Roquette Polysorb® 75/08/22. The polyglucitol powder was Polysorb® 96/02/01. Also in Table 9, “foam booster” was cappuccino foam booster obtained from Kraft Foods Inc., and the flavor was Lemon N&A 333240 25AH commercially available from Firmenich Inc., USA.

TABLE 9

| | Amounts |
|---|---|
| Components | (in weight percentages) |
| Polyglucitol liquid | 32.00 |
| Polyglucitol powder | 49.87 |
| Sodium alginate | 0.50 |
| Carboxymethylcellulose | 0.50 |
| Glycerin | 2.00 |
| Talc | 5.00 |
| Lecithin | 1.00 |
| Fat | 6.79 |
| Color (yellow #5) | 0.03 |
| Lemon Flavor | 0.38 |
| Sucralose | 0.28 |
| Citric acid | 0.94 |
| Trucal D7 ® | 1.00 |
| Foam booster | 1.50 |

To prepare the confectionery composition, a mixing kettle with Z-arm type mixer was heated to 60° C. Pre-heated liquid polyglucitol at 60° C. was added to the mixing kettle. Powder polyglucitol, sodium alginate, and carboxymethyl cellulose were added to the kettle and mixed. Water was added, and mixed to yield a homogeneous mass. Glycerin and talc were added to the homogenous mass and mixed. Color was added and the resulting mixture was mixed. Pre-melted fat and lecithin were added and mixed until a homogeneous mixture was formed. The mixture was allowed to cool, and then flavors, acids, and sweeteners were added as the mass started to become viscous (at about 40° C.). Trucal D7® and cappuccino foam booster were added to the viscous mass and mixed. The composition was discharged from the kettle and formed into candy pieces, which were wrapped to protect from cold flow.

### EXAMPLE 10

### Chewy Candy

This example demonstrates the preparation of chewy candy composition incorporating a blend of liquid and powdered polyglucitol components. The composition is summarized in Table 10, where “Polyglucitol liquid” was Roquette Polysorb 75/08/22, “Polyglucitol powder” was Roquette Polysorb 96/02/01, and Foam booster was cappuccino foam booster available from Kraft Foods Inc. The flavor was Lemon N&A 333240 25AH commercially available from Firmenich Inc., USA.

TABLE 10

| | Amounts |
|---|---|
| Component | (in weight percentages) |
| Polyglucitol liquid | 40.00 |
| Polyglucitol powder | 46.50 |
| Sodium alginate | 0.25 |
| Carboxymethylcellulose | 0.25 |
| Glycerin | 2.00 |
| Talc | 1.00 |
| Lecithin | 1.00 |
| Glycerol monostearate | 1.79 |
| Cottonseed oil | 2.00 |
| Color | 0.03 |
| Flavor | 0.38 |
| Sucralose | 0.28 |
| Citric acid | 0.94 |
| Calcium source | 1.00 |
| (Trucal D7 ®) | |
| Foam booster | 2.50 |

To prepare the confectionery composition, a mixing kettle with Z-arm type mixer was heated to 60° C. Pre-heated liquid polyglucitol at 60° C. was added to the mixing kettle. Powder polyglucitol, sodium alginate, and carboxymethyl cellulose were added to the kettle and mixed. Water was added, and mixed to yield a homogeneous mass. Glycerin and talc were added to the homogenous mass and mixed. Color was added and the resulting mixture was mixed. Vegetable oil, lecithin, and glycerol monostearate were added and mixed until a homogeneous mixture was formed. The mixture was allowed to cool, and then flavors, acids, and sweeteners were added as the mass started to become viscous (at about 40° C.). Trucal D7® and foam booster were added to the viscous mass and mixed. The composition was discharged from the kettle and formed into candy pieces, which were wrapped to protect from cold flow.

### EXAMPLE 11

### Chewy Candy

This example demonstrates the preparation of another chewy candy composition incorporating a blend of liquid and powdered polyglucitol components. The composition is summarized in Table 11, where “Polyglucitol liquid” was Roquette Polysorb 75/08/22, “Polyglucitol powder” was Roquette Polysorb 96/02/01, and Foam booster was cappuccino foam booster available from Kraft foods Inc. The flavor was Orange N&A 540507A (758908 17501A) commercially available from Firmenich Inc., USA.

TABLE 11

| | Amounts |
|---|---|
| Component | (in weight percentages) |
| Polyglucitol liquid | 40.00 |
| Polyglucitol powder | 44.00 |
| Gelatin 160 Bloom | 4.00 |
| Glycerin | 2.00 |
| Talc | 1.00 |
| Lecithin | 1.00 |
| Glycerol monostearate | 1.79 |
| Cottonseed oil | 2.00 |
| Color | 0.03 |
| Flavor | 0.38 |
| Sucralose | 0.28 |
| Citric acid | 0.94 |
| Foam booster | 2.50 |

To prepare the confectionery composition, a mixing kettle with Z-arm type mixer was heated to 60° C. Pre-heated liquid polyglucitol at 60° C. was added to the mixing kettle. Powder polyglucitol was added to the kettle and mixed. Water was added, and mixed to yield a homogeneous mass. Glycerin, talc, and prehydrated gelatin were added to the homogenous mass and mixed. Color was added and the resulting mixture was mixed. Pre-heated vegetable oil, lecithin, and glycerol monomstearate were added and mixed until a homogeneous mixture was formed. The mixture was allowed to cool, and then flavor, acid, and sweetener were added as the mass started to become viscous (at about 40° C.). Foam booster was added to the viscous mass and mixed. The composition was discharged from the kettle and formed into candy pieces, which were wrapped to protect from cold flow.

### EXAMPLE 12

### Chewy Candy

This example demonstrates the preparation of another chewy candy composition incorporating a blend of liquid and powdered polyglucitol components. The composition is summarized in Table 12, where “Polyglucitol liquid” was Roquette Polysorb 75/08/22, “Polyglucitol powder” was Roquette Polysorb 96/02/01, and Foam booster was cappuccino foam booster available from Kraft foods Inc. The flavor was Orange N&A 540507A (758908 17501A) commercially available from Firmenich Inc., USA.

TABLE 12

| | Amounts |
|---|---|
| Component | (in weight percentages) |
| Polyglucitol liquid | 40.00 |
| Polyglucitol powder | 44.00 |
| Gelatin 250 Bloom | 4.00 |
| Glycerin | 2.00 |
| Talc | 1.00 |
| Lecithin | 1.00 |
| Glycerol monostearate | 1.79 |
| Cottonseed oil | 2.00 |
| Color | 0.03 |
| Flavor | 0.38 |
| Sucralose | 0.28 |
| Citric acid | 0.94 |
| Foam booster | 2.50 |

To prepare the confectionery composition, a mixing kettle with Z-arm type mixer was heated to 60° C. Pre-heated liquid polyglucitol at 60° C. was added to the mixing kettle. Powder polyglucitol was added to the kettle and mixed. Water was added, and mixed to yield a homogeneous mass. Glycerin, talc, and prehydrated gelatin were added to the homogenous mass and mixed. Color was added and the resulting mixture was mixed. Cottonseed oil, lecithin, and glycerol monostearate were added and mixed until a homogeneous mixture was formed. The mixture was allowed to cool, and then flavor, acid, and sweetener were added as the mass started to become viscous (at about 40° C.). Foam booster was added to the viscous mass and mixed. The composition was discharged from the kettle and formed into candy pieces, which were wrapped to protect from cold flow.

### EXAMPLE 13

### Chewy Candy

This example demonstrates the preparation of another chewy candy composition incorporating a blend of liquid and powdered polyglucitol components. The composition is summarized in Table 13, where “Polyglucitol liquid” was Roquette Polysorb 75/08/22, “Polyglucitol powder” was Roquette Polysorb 96/02/01, foam booster was cappuccino foam booster available from Kraft foods Inc., and the flavor was caramel flavor.

TABLE 13

| | Amounts |
|---|---|
| Component | (in weight percentages) |
| Polyglucitol liquid | 42.00 |
| Polyglucitol powder | 40.50 |
| Gelatin | 2.50 |
| Glycerin | 2.00 |
| Lecithin | 1.00 |
| Glycerol monostearate | 1.79 |
| Cottonseed oil | 2.00 |
| Color | 0.03 |
| Caramel Flavor | 0.38 |
| Sucralose | 0.28 |
| Citric acid | 0.94 |
| Foam booster | 2.50 |
| Calcium Source (Trucal | 5.00 |
| D7 ®) | |

To prepare the confectionery composition, a mixing kettle with Z-arm type mixer was heated to 60° C. Pre-heated liquid polyglucitol at 60° C. was added to the mixing kettle. Powder polyglucitol was added to the kettle and mixed. Water was added, and mixed to yield a homogeneous mass. Glycerin and pre-hydrated gelatin were added to the homogenous mass and mixed. Color was added and the resulting mixture was mixed. Cottonseed oil, lecithin, and glycerol monostearate were added and mixed until a homogeneous mixture was formed. The mixture was allowed to cool, and then flavors, acids, and sweeteners were added as the mass started to become viscous (at about 40° C.). Trucal D7® and foam booster were added to the viscous mass and mixed. The composition was discharged from the kettle and formed into candy pieces, which were wrapped to protect from cold flow.

The uncooked candy compositions prepared in Examples 1-13 were manually tested for physical appearance, taste, texture, and chew properties. The uncooked candy compositions of Examples 1-13 were substantially similar in physical appearance, taste, texture, and chew to corresponding cooked candies. For example, the uncooked hard candies possessed hardness almost equal to that of the traditional cooked candies, and the uncooked chewy candy possessed chew-texture almost identical to traditional chewy candies.

### EXAMPLE 14

### Chewing Gum Comprising a Hard Candy

This example demonstrates the preparation of a chewing gum composition incorporating a confectionery composition of Example 1. The composition is summarized in Table 14.

TABLE 14

| | Amounts |
|---|---|
| Component | (in weight percentages) |
| Gum base | 25-35 |
| Additional bulk sweeteners | 0-55 |
| Additional flavor/sensate | 0-5 |
| Additional food grade acid | 0-3 |
| High intensity sweetener | 0-5 |
| Color | 0-2 |
| Composition of Example 1 | 8-16 |
| Total chewing gum (wt %) | 100 |

The gum base is melted using techniques known in the art. The bulk sweeteners (such as Mannitol, Sorbitol, Maltitol or combinations thereof) and optional color are then added with mixing. The optional additional flavor/sensate are added with mixing followed by the addition of optional high intensity sweeteners to form a chewing gum mixture. The chewing gum mixture is maintained in the molten state.

The hard candy composition is prepared as described in Example 1. The chewing gum mixture is then mixed with the hard candy composition while the hard candy composition is hot and viscous. The chewing gum composition, thus formed, can be formed into pieces, and optionally coated using techniques known in the art.

### EXAMPLE 15

### Chewing Gum Comprising a Chewy Candy

This example demonstrates the preparation of a chewing gum composition incorporating a confectionery composition of Example 8. The composition is summarized in Table 15.

TABLE 15

| | Amounts |
|---|---|
| Component | (in weight percentages) |
| Gum base | 25-35 |
| Additional bulk sweeteners | 0-55 |
| Additional flavor/sensate | 0-5 |
| Additional food grade acid | 0-3 |
| High intensity sweetener | 0-5 |
| Color | 0-2 |
| Composition of Example 8 | 8-16 |
| Total chewing gum (wt %) | 100 |

The gum base is melted using techniques known in the art. The bulk sweeteners (such as Mannitol, Sorbitol, Maltitol or combinations thereof) and optional color are then added with mixing. The optional additional flavor/sensate are added with mixing followed by the addition of optional high intensity sweeteners to form a chewing gum mixture. The chewing gum mixture is maintained in the molten state.

A chewy candy composition is prepared as described in Example 8. The chewing gum mixture is then mixed with the chewy candy composition while the chewy candy composition is hot and viscous. The chewing gum composition, thus formed, can be formed into pieces, and optionally coated using techniques known in the art.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

As used herein the transitional term “comprising” (also “comprises,” etc.) which is synonymous with “including”, “containing”, or “characterized by” is inclusive or open-ended and does not exclude additional, unrecited elements or method steps, regardless of its use in the preamble or the body of a claim.

The term “combination” is inclusive of a homogenous or non-homogenous blend, mixture, or alloy of the named components into an integrated whole. The term “homogenous” refers to a uniform blend of the components.

The word “or” means “and/or.”

All ranges disclosed herein are inclusive of the endpoints, and the endpoints are independently combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of forming a confectionery composition, comprising:
blending components comprising
about 35 to about 95 weight percent of a polyglucitol having a degree of polymerization of at least 3, and
about 5 to about 13 weight percent water,
at a temperature of about 50° C. to about 85° C. to form a confectionery composition;
wherein the confectionery composition retains at least 90 percent of the water; and
wherein all weight percents are based on the weight of the confectionery composition, unless another basis is specified.

2. The method of claim 1,
wherein said polyglucitol has the structure 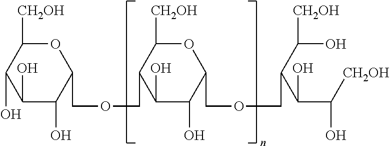
wherein n is at least 1.

3. The method of claim 1, wherein said forming the confectionery composition is conducted entirely at temperatures less than or equal to 85° C.

4. The method of claim 1, wherein said forming the confectionery composition is conducted entirely at a pressure of about 90 to about 110 kilopascals.

5. The method of claim 1, wherein said confectionery composition is substantially free of gum arabic, carrageenan, locust bean gum, guar gum, and gelatin.

6. The method of claim 1, wherein the confectionery composition comprises no more than 10 weight percent sorbitol.

7. (canceled)

8. The method of claim 1, wherein the confectionery composition comprises no more than 20 weight percent maltitol.

9. (canceled)

10. The method of claim 1, wherein the amount of the polyglucitol is at least 50 weight percent of the total of sorbitol, maltitol, and the polyglucitol.

11. The method of claim 1, wherein the blended components comprise about 70 to about 95 weight percent of the polyglucitol.

12. (canceled)

13. The method of claim 1, wherein about 30 to about 70 weight percent of the polyglucitol is provided in the form of a powdered polyglucitol composition comprising, based on the weight of the powdered polyglucitol composition, about 50 to about 99 weight percent polyglucitol having a degree of polymerization of at least 3, and less than or equal to 1 weight percent water; and
about 30 to about 70 weight percent of the polyglucitol is provided in the form of a liquid polyglucitol composition comprising, based on the weight of the liquid polyglucitol composition, about 30 to about 80 weight percent polyglucitol having a degree of polymerization of at least 3, and about 20 to about 40 weight percent water.

14. The method of claim 1, wherein the blended components comprise about 35 to about 50 weight percent of the polyglucitol; and
wherein the blended components further comprise about 35 to about 55 weight percent of a polyol selected from the group consisting of sorbitol, mannitol, erythritol, xylitol, maltitol, isomalt, and combinations thereof.

15. The method of claim 1, wherein the blended components further comprise about 1 to about 10 weight percent of an edible fat or oil.

16. The method of claim 1, wherein the blended components further comprise
about 0.3 to about 3 weight percent of sodium bicarbonate, potassium bicarbonate, or a combination thereof; and
about 0.3 to about 2.5 weight percent of a food-grade acid.

17. The method of claim 1, wherein the blended components further comprise about 1 to about 5 weight percent of a foaming agent.

18. The method of claim 1, wherein the blended components further comprise about 0.5 to about 10 weight percent of a hydrocolloid.

19. The method of claim 1,
wherein the forming the confectionery composition is conducted entirely at temperatures less than or equal to 85° C.;
wherein the blended components comprise about 70 to about 95 weight percent of the polyglucitol;
wherein the confectionery composition comprises less than or equal to 10 weight percent sorbitol;
wherein the confectionery composition comprises less than or equal to 20 weight percent maltitol;
wherein the amount of the polyglucitol is at least 60 weight percent of the total of sorbitol, maltitol, and polyglucitol;
wherein the blended components further comprise about 0.5 to about 2 weight percent of an edible fat or oil; and
wherein the blended components are substantially free of gum arabic, carrageenan, locust bean gum, guar gum, and gelatin.

20. The method of claim 1,
wherein the forming the confectionery composition is conducted entirely at temperatures less than or equal to 85° C.;
wherein the polyglucitol is provided in the form of a blend of
about 30 to about 70 weight percent of a powdered polyglucitol composition comprising, based on the weight of the powdered polyglucitol composition, about 50 to about 99 weight percent polyglucitol having a degree of polymerization of at least 3, and less than or equal to 1 weight percent water, and
about 30 to about 70 weight percent of a liquid polyglucitol composition comprising based on the weight of the liquid polyglucitol composition, about 30 to about 80 weight percent polyglucitol having a degree of polymerization of at least 3, and about 20 to about 40 weight percent water;
wherein the blended components further comprise about 35 to about 55 weight percent of a polyol selected from the group consisting of sorbitol, mannitol, erythritol, xylitol, maltitol, isomalt, and combinations thereof; and
wherein the blended components further comprise about 1 to about 10 weight percent of an edible fat or oil.

21. (canceled)

22. A confectionery composition, comprising:
about 70 to about 95 weight percent of a polyglucitol having a degree of polymerization of at least 3; and
about 5 to about 10 weight percent water,
wherein the confectionery composition comprises less than or equal to 10 weight percent sorbitol;
wherein the confectionery composition comprises less than or equal to 20 weight percent maltitol;
wherein the amount of the polyglucitol is at least 60 weight percent of the total of sorbitol, maltitol, and polyglucitol; and
wherein the confectionery composition further comprise about 0.5 to about 2 weight percent of an edible fat or oil.

23. (canceled)

24. A confectionery composition comprising
about 35 to about 50 weight percent of the a polyglucitol having a degree of polymerization of at least 3;
about 35 to about 55 weight percent of a polyol selected from the group consisting of sorbitol, mannitol, erythritol, xylitol, maltitol, isomalt, and combinations thereof; and
about 5 to about 10 weight percent water,
wherein the confectionery composition further comprise about 1 to about 10 weight percent of an edible fat or oil.

25. A confectionery article, comprising:
a first layer comprising a chewing gum composition; and
a second layer disposed on the first layer;
wherein the second layer comprises a confectionery composition comprising, based on the weight of the confectionery composition,
about 35 to about 95 weight percent of a polyglucitol, and
about 5 to about 10 weight percent water.

26. (canceled)

27. A chewing gum composition, comprising
a gum base; and
a confectionery composition, comprising:
about 35 to about 95 weight percent of a polyglucitol having a degree of polymerization of at least 3; and
about 5 to about 10 weight percent water,
wherein the gum base and the confectionery composition are homogenously mixed together.

28. The method of claim 1,
wherein the confectionery composition is selected from the group consisting of hard candy, soft candy, chewy candy, lozenge, toffees, fudges, fondants, jellies, gummies, pastilles, caramels, taffies, nougats, chewing gums, and combinations thereof.
